(19) United States
(12) Patent Application Publication
(10) Pub. No.: US 2009/0276622 A1
(43) Pub. Date: Nov. 5, 2009

(54) SECRET AUTHENTICATION SYSTEM

(75) Inventor: Masakatsu MATSUO, Fukuoka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/427,979

(22) Filed: Apr. 22, 2009

(30) Foreign Application Priority Data
May 1, 2008 (JP) 2008-119619

(51) Int. Cl. H04L 9/00; G06F 15/16

(52) U.S. Cl. 713/155; 726/3

(57) ABSTRACT

Authentication data is distributedly defined by a plurality of distributed data, including function data specifying a function. A portion of the distributed data is shared between an authenticated apparatus and an authenticating apparatus. The authenticated apparatus obtains verification data from the distributed data unshared with the authenticated apparatus, and transmits the verification data. The authenticating apparatus verifies authenticity of the authenticated apparatus, based on the verification data and the like received from the authenticated apparatus. The authenticated apparatus generates the distributed data containing predetermined control data, and transmits the distributed data to the authenticating apparatus. The authenticating apparatus extracts the control data from the distributed data containing the control data, and determines whether or not authentication is granted based on the control data.

### CROSS-REFERENCE TO RELATED APPLICATIONS

The present application claims priority under 35 U.S.C. §119 of Japanese Application No. 2008-119619 filed on May 1, 2008, the disclosure of which is expressly incorporated by reference herein in its entirety.

### BACKGROUND OF THE INVENTION

1. Field of the Invention

The present invention relates to a secret authentication system in which an authenticated apparatus notifies an authenticating apparatus of authentication data, so that authentication is performed while others are kept from knowing the data.

2. Description of Related Art

Systems providing a variety of services from a server to terminals connected via a network have rapidly been spreading recently, represented as Internet commerce systems, including Internet banking and Internet shopping. In the systems, which require an authentication system that verifies whether or not users are properly registered, authentication data, such as passwords, are transmitted on the network. Due to the nature of the systems, various technologies are known to prevent improper acts of making illicit gains through spoofing by using authentication data stolen from proper users (refer to Related Art 1, for example).

In addition, contactless IC cards functioning as electronic money have quickly been spreading recently. Contactless IC cards and RFID tags are getting used in entry control systems and merchandise control systems. In the systems of this type using RFID devices, it is necessary to prevent improper acts of making illicit gains through spoofing by using skimmed authentication data. Some schemes are known in order to increase security of the RFID devices, including a randomized hash lock scheme, a hash chain scheme (refer to Related Art 2), and a re-encryption scheme (refer to Related Art 3).
[Related Art 1] Japanese Patent Laid-open Publication No. 2007-293787
[Related Art 2] Japanese Patent Re-publication of PCT International Application No. 2005-031579
[Related Art 3] Japanese Patent Laid-open Publication No. 2004-317764

A variety of conventional technologies are able to increase secrecy of authentication data by employing complex calculation processes, but unable to sufficiently satisfy cost reduction demands since the technologies require high-speed computation devices that increase costs. It is thus desired to provide a technology capable of achieving both cost reduction and high secrecy. In particular, various intermediary attacks are problems, including wiretapping and tampering by intermediaries intervening in communication between authenticated apparatuses and authenticating apparatuses. It is thus desired to provide a system capable of surely preventing this type of intermediary attacks.

### SUMMARY OF THE INVENTION

The present invention is provided to address the above-described problems in the conventional technologies. A main advantage of the present invention is to provide a secret authentication system configured so as to ensure high secrecy and to reduce computation load to achieve cost reduction. Further, the present invention provides a secret authentication system capable of preventing a variety of intermediary attacks.

The present invention provides a secret authentication system in which an authenticating apparatus and an authenticated apparatus perform authentication therebetween using a function. The authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function. The authenticated apparatus and the authenticating apparatus share the type of the function and a portion of plurality of distributed data including the authentication data, the rule data, and the function data. The authenticated apparatus performs a calculation for the distributed data unshared with the authenticating apparatus in a process difficult for a third party to perform a back calculation, so as to obtain verification data, and transmits the verification data to the authenticating apparatus. The authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus. The authenticated apparatus generates data containing control data as one of the distributed data, and transmits the generated data to the authenticating apparatus. The authenticating apparatus retrieves the control data from the distributed data containing the control data, and determines whether to grant authentication based on the control data. Among the distributed data, the function data is data uniquely determining the function, such as, for example, a coordinate value of a point on a function of first- or n-degree; a value of a coefficient, gradient, and intercept of a function expression; and the like. Further, among the distributed data, the rule data is a rule specifying the authentication data from a function. For instance, when the authentication data is a Y value of a point on a function of first- or n-degree, an X value of the point is the rule data. Furthermore, the authentication data is data indicating authenticity of the authenticated apparatus, such as, including a password provided to the authenticated apparatus or a user thereof, and biometrics information of the user of the authenticated apparatus.

The present invention further provides a secret authentication system, in which an authenticated apparatus generates integrated data by adding control data to one of authentication data and key data, the authentication data indicating authenticity of one of the authenticated apparatus and a user thereof; obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to an authenticating apparatus. The authenticating apparatus then decrypts the encrypted data received from the authenticated apparatus; extracts the control data; and determines whether to grant authentication based on the control data.

The present invention further provides a secret authentication system in which an authenticating apparatus and an authenticated apparatus perform authentication therebetween using a function. The authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function. The authenticated apparatus and the authenticating apparatus share the type of the function and a portion of plurality of distributed data including the authentication data, the rule data, and the function data. The authenticated apparatus performs a calculation for the distributed data unshared with the authenticating apparatus in a process difficult for a third party to perform a back calculation, so as to obtain verification data, and transmits the verification data to the authenticating apparatus. The authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus. The authenticated apparatus generates at least a portion of the distributed data from unique data of one of the authenticated apparatus and the authenticating apparatus. The authenticating apparatus generates the distributed data identical to the data of the authenticated apparatus, from the unique data of one of the authenticated apparatus and the authenticating apparatus. Among the distributed data, the function data is data uniquely determining the function, such as, for example, a coordinate value of a point on a function of first- or n-degree; a value of a coefficient, gradient, and intercept of a function expression; and the like. Further, among the distributed data, the rule data is a rule specifying the authentication data. For instance, when the authentication data is a Y value of a point on a function of first- or n-degree, an X value of the point is the rule data. Furthermore, the authentication data is data indicating authenticity of the authenticated apparatus, such as, including a password provided to the authenticated apparatus or a user thereof, and biometrics information of the user of the authenticated apparatus.

The present invention further provides a secret authentication system, in which an authenticated apparatus generates integrated data by adding unique data of one of the authenticated apparatus and an authenticating apparatus, to one of authentication data and key data, the authentication data indicating authenticity of one of the authenticated apparatus and a user thereof; obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to the authenticating apparatus. The authenticating apparatus then verifies authenticity of the authenticated apparatus, based on the unique data of one of the authenticated apparatus and the authenticating apparatus, the encrypted data received from the authenticated apparatus, and authentication data stored in the authenticating apparatus.

According to the present invention, even when an intermediary intercepts data transmitted from the authenticated apparatus to the authenticating apparatus, the intermediary intervening in communication between the authenticated apparatus to the authenticating apparatus, the intermediary cannot obtain the authentication data, and thus high secrecy can be ensured. Further, a reduced calculation load allows use of low speed calculator, thus reducing the cost. Particularly, in accordance with change of contents of the control data due to elapse of the time and other factors, data exchanged between the authenticated apparatus and the authenticating apparatus changes. Thus, the intermediary cannot receive authentication improperly by copying communication between the authenticating apparatus and the authenticated apparatus and using the data used in the communication, and thereby retry attacks can be prevented. Further, the data exchanged between the authenticating apparatus and the authenticated apparatus is generated based on the unique data of the authenticating apparatus or the authenticated apparatus. Thus, when the intermediary is present intervening in communication between the authenticating apparatus and the authenticated apparatus, the intermediary's intervention is revealed due to discrepancy in the unique data, and thus intermediary attacks can be reduced.

A first aspect of the present invention provides a secret authentication system in which an authenticating apparatus and an authenticated apparatus perform authentication therebetween using a function. The authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function. The authenticated apparatus and the authenticating apparatus share the type of the function and a portion of plurality of distributed data including the authentication data, the rule data, and the function data. The authenticated apparatus performs a calculation for the distributed data unshared with the authenticating apparatus in a process difficult for a third party to perform a back calculation, so as to obtain verification data, and transmits the verification data to the authenticating apparatus. The authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus. The authenticated apparatus generates data containing control data as one of the distributed data, and transmits the generated data to the authenticating apparatus. The authenticating apparatus retrieves the control data from the distributed data containing the control data, and determines whether to grant authentication based on the control data.

In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function, such as a linear function, reduces calculation load. A low speed calculation device will thus suffice, and the cost can be reduced.

Particularly, in accordance with change of contents of the control data due to elapse of the time and other factors, the distributed data exchanged between the authenticating apparatus and the authenticated apparatus changes. Thus, the intermediary cannot receive authentication improperly by copying communication between the authenticating apparatus and the authenticated apparatus and using the data used in the communication, and thereby retry attacks can be prevented.

In this case, when the authenticating apparatus determines that authentication is possible based on the control data, the authenticating apparatus verifies authenticity of the authenticated apparatus based on the distributed data received from the authenticated apparatus and the authentication data per authenticated apparatus stored in the authenticating apparatus.

Among the distributed data, the function data is data uniquely determining the function, such as, for example, a coordinate value of a point on a function of first- or n-degree; a value of a coefficient, gradient, and intercept of a function expression; and the like. When a coordinate value of a point on a line or a curve of an n-degree function is used as the function data, an X value and a Y value of a point of n+1 are the function data, and uniquely determine the function.

Further, among the distributed data, the rule data is a rule specifying the authentication data. For instance, when the authentication data is a Y value of a point on a function of first- or n-degree, an X value of the point is the rule data. The authentication data may be a coordinate value of an intersection point of a first function of first- or n-degree and a second function of first- or n-degree. In this case, a value specifying the second function of first- or n-degree forming the intersection point is the rule data. Further, the authentication data may be a coefficient of a function expression. In this case, data specifying the coefficient as the authentication data is the rule data.

The authentication data is data indicating authenticity of the authenticated apparatus, such as, including a password provided to the authenticated apparatus or a user thereof, and biometrics information of the user of the authenticated apparatus.

In the aspect of the present invention, the authenticated apparatus needs to generate the distributed data, so as to allow the authenticating apparatus to extract the control data from the distributed data. For the data generation, predetermined control data may be used as the distributed data as it is. Alternatively, the distributed data may be generated by combining the control data with appropriate data (random number data and the like). The shared distributed data may include the authentication data and the rule data. The distributed data shared between the authenticated apparatus and the authenticating apparatus and stored therein may be the authentication data.

An another aspect of the present invention provides a secret authentication system, in which an authenticated apparatus generates integrated data by adding control data to one of authentication data and key data, the authentication data indicating authenticity of one of the authenticated apparatus and a user thereof; obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to an authenticating apparatus. The authenticating apparatus then decrypts the encrypted data received from the authenticated apparatus; extracts the control data; and determines whether to grant authentication based on the control data.

In the configuration above, even when an intermediary intervening in communication between the authenticated apparatus an the authenticating apparatus intercepts the encrypted data transmitted from the authenticated apparatus to the authenticating apparatus, the intermediary cannot obtain the authentication data from the encrypted data without knowing the key data. Thereby, high secrecy can be ensured. In addition, a simple cryptographic operation, such as product operation and the like, used in processes on the authenticated apparatus and the authenticating apparatus reduces calculation load and thus cost.

In particular, the encrypted data exchanged between the authenticating apparatus and the authenticated apparatus changes. Thus, the intermediary cannot receive authentication improperly by copying communication between the authenticating apparatus and the authenticated apparatus and using the data used in the communication, and thereby retry attacks can be prevented.

In the aspect of the present invention, the authenticated apparatus needs to generate the integrated data, so as to allow the authenticating apparatus to extract the control data from the integrated data. For the data generation, for example, the authentication data or the key data may be combined with the control data for integration.

A still further aspect of the present invention provides the secret authentication system according to the first aspect, in which the control data includes information related to time when a process is performed for one of generating the control data and indicating an effective period of the control data.

In the configuration above, authentication can be limited based on the time. In this case, for example, the authenticating apparatus compares the time information received from the authenticated apparatus against the current time. When determining that the time is out of a predetermined range, the authenticating apparatus rejects authentication or puts a certain limit on authentication.

A yet further aspect of the present invention provides the secret authentication system according to the first aspect, in which the control data includes information related to the number of access from the authenticated apparatus to the authenticating apparatus.

In the configuration above, authentication can be limited based on the access count. In this case, for example, the authenticating apparatus compares the access count information received from the authenticated apparatus against the current access count. When determining that the access count is out of a predetermined range, the authenticating apparatus rejects authentication or puts a certain limit on authentication. The access count herein refers to the number of authentication that the authenticated apparatus requests for the authenticating apparatus.

A still another aspect of the present invention provides the secret authentication system according to the first aspect, in which the control data includes information related to authorization of access from the authenticated apparatus to the authenticating apparatus.

In the configuration above, authorization can be performed based on access authorization. The access authorization information herein refers to a time period during which access is allowed, such as, for example, a time period when server access authorization is temporarily transferred to another person. Access after successful authentication may be limited, by adding information setting a range of authorization, such as access limit after authentication, including whether or not a person can provide approval, browse or edit data, and the like.

A yet further aspect of the present invention provides a secret authentication system in which an authenticating apparatus and an authenticated apparatus perform authentication therebetween using a function. The authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function. The authenticated apparatus and the authenticating apparatus share the type of the function and a portion of plurality of distributed data including the authentication data, the rule data, and the function data. The authenticated apparatus performs a calculation for the distributed data unshared with the authenticating apparatus in a process difficult for a third party to perform a back calculation, so as to obtain verification data, and transmits the verification data to the authenticating apparatus. The authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus. The authenticated apparatus generates at least a portion of the distributed data from unique data of one of the authenticated apparatus and the authenticating apparatus. The authenticating apparatus generates the distributed data identical to the data of the authenticated apparatus, from the unique data of one of the authenticated apparatus and the authenticating apparatus.

In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function, such as a linear function, reduces calculation load. A low speed calculation device will thus suffice, and the cost can be reduced.

In particular, the distributed data exchanged between the authenticating apparatus and the authenticated apparatus is generated based on the unique data of the authenticating apparatus or the authenticated apparatus. Thus, when an intermediary is present intervening in communication between the authenticating apparatus and the authenticated apparatus, the intermediary's intervention is revealed due to discrepancy in the unique data, and thus intermediary attacks can be reduced.

In the aspect of the present invention, the authenticated apparatus does not need to generate the distributed data, so as to allow the authenticating apparatus to extract the control data from the distributed data. An appropriate process may be employed in which the authenticated apparatus and the authenticating apparatus generate identical distributed data from the unique data identical to each other. The shared distributed data may include the authentication data and the rule data. The distributed data shared between the authenticated apparatus and the authenticating apparatus and stored therein may be the authentication data.

A further aspect of the present invention provides a secret authentication system, in which an authenticated apparatus generates integrated data by adding unique data of one of the authenticated apparatus and an authenticating apparatus, to one of authentication data and key data, the authentication data indicating authenticity of one of the authenticated apparatus and a user thereof; obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to the authenticating apparatus. The authenticating apparatus then verifies authenticity of the authenticated apparatus, based on the unique data of one of the authenticated apparatus and the authenticating apparatus, the encrypted data received from the authenticated apparatus, and authentication data stored in the authenticating apparatus.

In the configuration above, even when an intermediary intervening in communication between the authenticated apparatus an the authenticating apparatus intercepts the encrypted data transmitted from the authenticated apparatus to the authenticating apparatus, the intermediary cannot obtain the authentication data from the encrypted data without knowing the key data. Thereby, high secrecy can be ensured. In addition, a simple cryptographic operation, such as product operation and the like, used in processes on the authenticated apparatus and the authenticating apparatus reduces calculation load and thus cost.

In particular, the encrypted data exchanged between the authenticating apparatus and the authenticated apparatus is generated based on the unique data of the authenticating apparatus or the authenticated apparatus. Thus, when an intermediary is present intervening in communication between the authenticating apparatus and the authenticated apparatus, the intermediary's intervention is revealed due to discrepancy in the unique data, and thus intermediary attacks can be reduced.

In the aspect of the present invention, the authenticated apparatus does not need to generate the integrated data, so as to allow the authenticating apparatus to extract the control data from the integrated data. An appropriate process may be employed in which the authenticated apparatus and the authenticating apparatus generate identical integrated data from the unique data identical to each other.

An another aspect of the present invention provides the secret authentication system according to the further aspect, in which the unique data includes information related to a public key of the authenticating apparatus, such as, a server certificate and the like.

The information related to the public key, which is contained in the server certificate, is transferred to the authenticated apparatus in a negotiation process of SSL communication.

A further aspect of the present invention provides the secret authentication system according to the further aspect, in which the unique data includes information related to a network address of one of the authenticated apparatus and the authenticating apparatus.

The network address herein refers to an IP address and a MAC address identifying an apparatus on the network.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a configuration of a secret authentication system according to the present invention;

FIGS. 2A and 2B illustrate a scheme of secret authentication according to the present invention;

FIGS. 3A and 3B illustrate the scheme of the secret authentication according to the present invention;

FIG. 4 illustrates a scheme of the secret authentication according to the present invention in another example;

FIG. 5 is a block diagram illustrating a first embodiment of a server and a client shown in FIG. 1;

FIG. 6 is a block diagram illustrating a second embodiment of the server and the client shown in FIG. 1;

FIG. 7 is a block diagram illustrating a third embodiment of the server and the client shown in FIG. 1;

FIG. 8 is a block diagram illustrating a fourth embodiment of the server and the client shown in FIG. 1;

FIG. 9 is a block diagram illustrating a fifth embodiment of the server and the client shown in FIG. 1;

FIG. 10 is a block diagram illustrating a sixth embodiment of the server and the client shown in FIG. 1;

FIG. 11 is a block diagram illustrating a seventh embodiment of the server and the client shown in FIG. 1;

FIG. 12 is a block diagram illustrating an eighth embodiment of the server and the client shown in FIG. 1;

FIG. 13 is a block diagram illustrating a ninth embodiment of the server and the client shown in FIG. 1;

FIG. 14 is a block diagram illustrating a tenth embodiment of the server and the client shown in FIG. 1;

FIG. 15 is a block diagram illustrating an eleventh embodiment of the server and the client shown in FIG. 1;

FIG. 16 is a block diagram illustrating a twelfth embodiment of the server and the client shown in FIG. 1;

FIG. 17 is a block diagram illustrating a thirteenth embodiment of the server and the client shown in FIG. 1;

FIG. 18 is a block diagram illustrating a fourteenth embodiment of the server and the client shown in FIG. 1;

FIG. 19 is a block diagram illustrating a fifteenth embodiment of the server and the client shown in FIG. 1;

FIG. 20 is a block diagram illustrating a sixteenth embodiment of the server and the client shown in FIG. 1;

FIG. 21 is a block diagram illustrating a seventeenth embodiment of the server and the client shown in FIG. 1;

FIG. 22 is a block diagram illustrating an eighteenth embodiment of the server and the client shown in FIG. 1;

FIG. 23 is a block diagram illustrating a nineteenth embodiment of the server and the client shown in FIG. 1; and

FIG. 24 is a block diagram illustrating a twentieth embodiment of the server and the client shown in FIG. 1.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

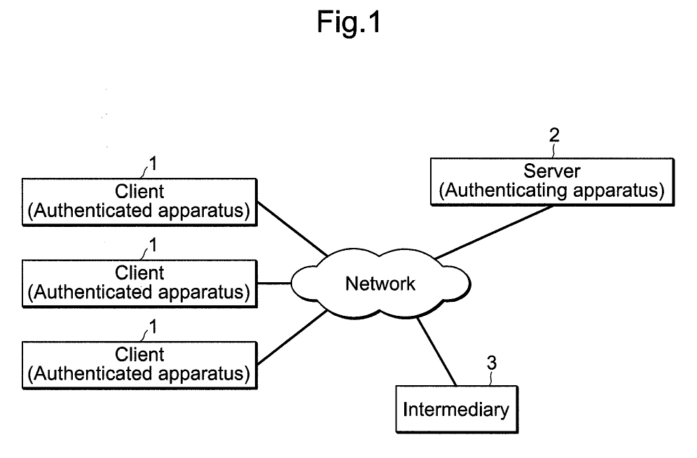

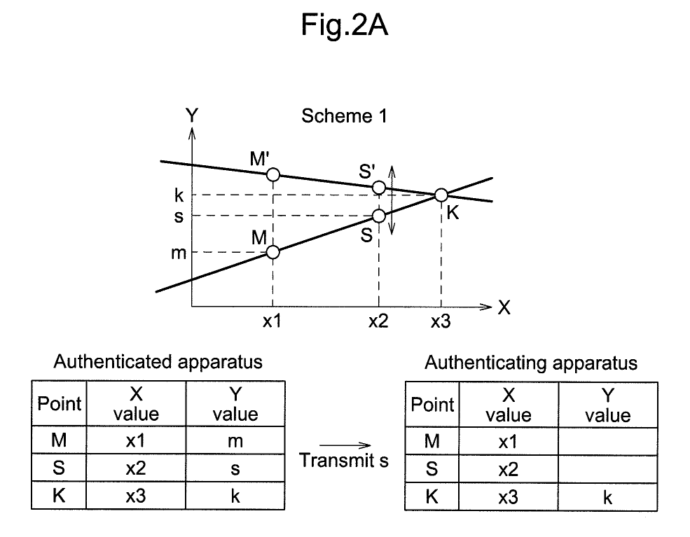

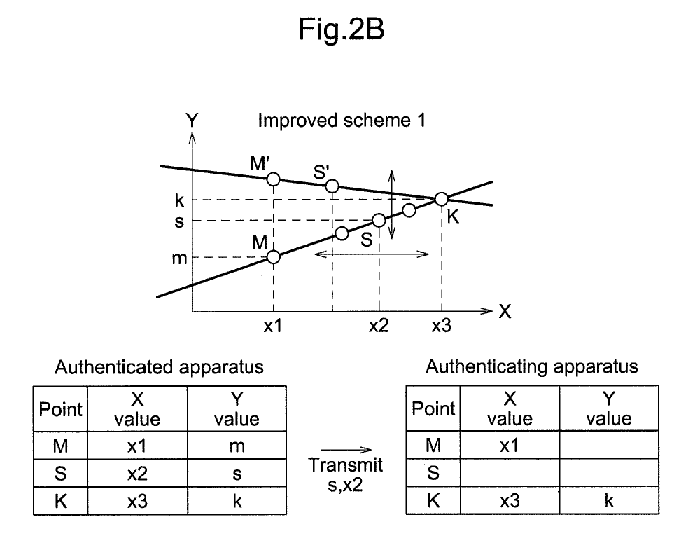

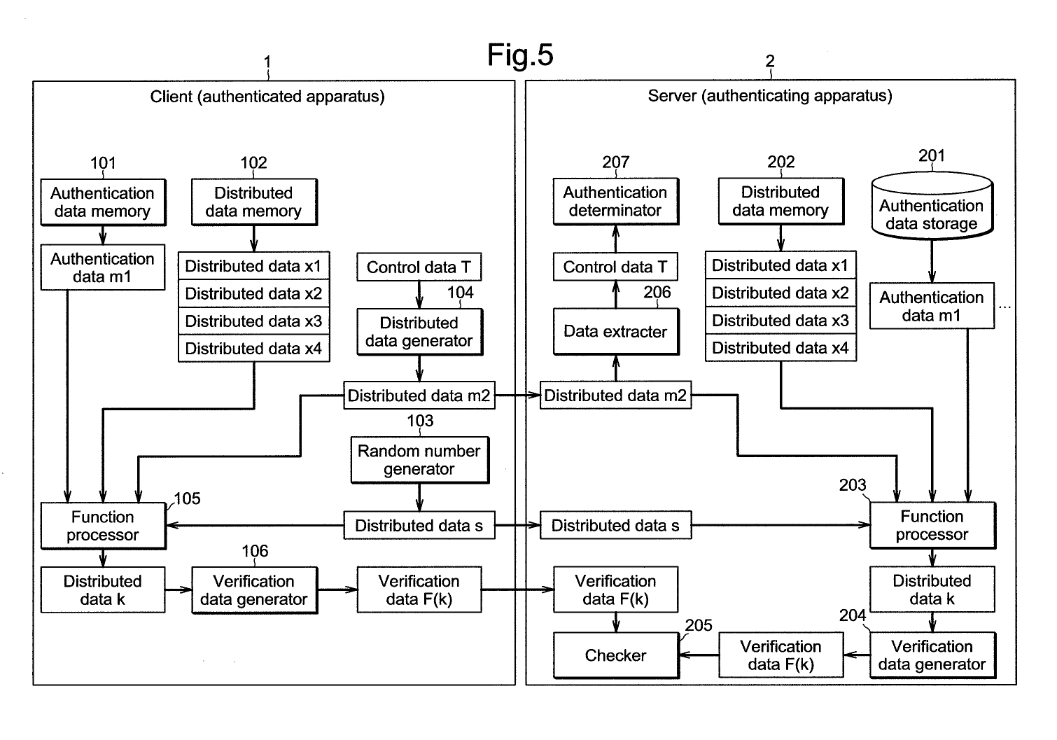

The embodiments of the present invention are explained below with reference to the drawings. A configuration of a secret authentication system according to the present invention is explained with reference to FIG. 1. Subsequently, basic concepts of secret authentication according to the present invention are explained with reference to FIGS. 2A to 4. Then, specific configuration examples are explained with reference to FIG. 5 and thereafter.

FIG. 1 illustrates a configuration of the secret authentication system according to the present invention. In the configuration, client (authenticated apparatus) 1 and server (authenticating apparatus) 2 are connected to each other on a network. Authentication data, including a password and the like, are stored in server 2 in advance. A user of client 1 provides an administrator of server 2, with the authentication data by way of a separate highly confidential method, such as, for example, mail and the like. Thereby, when the user of client 1 notifies server 2 of the authentication data using client 1, server 2 performs authentication of client 1. In the authentication system above, it is possible that intermediary 3 intervening in communication between client 1 and server 2 steals the authentication data, and that intermediary 3 masquerading as proper client 1 improperly receives authentication from server 2. In order to prevent the improper acts, the secret authentication system described below is employed.

<Secret Distribution System>

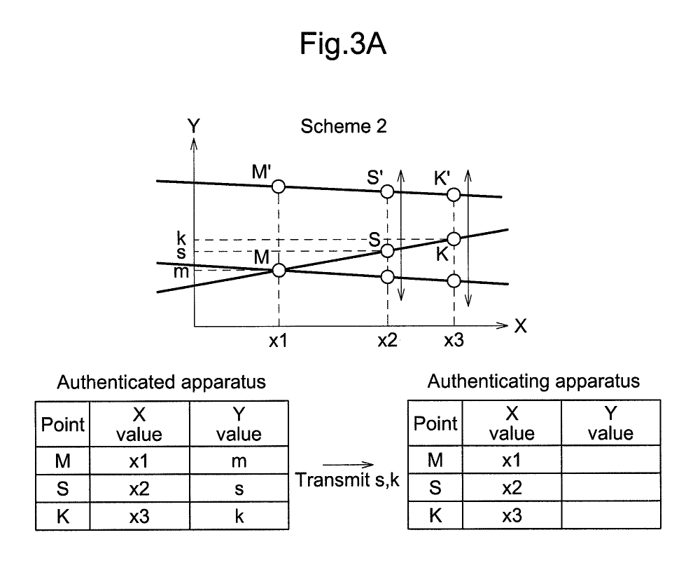

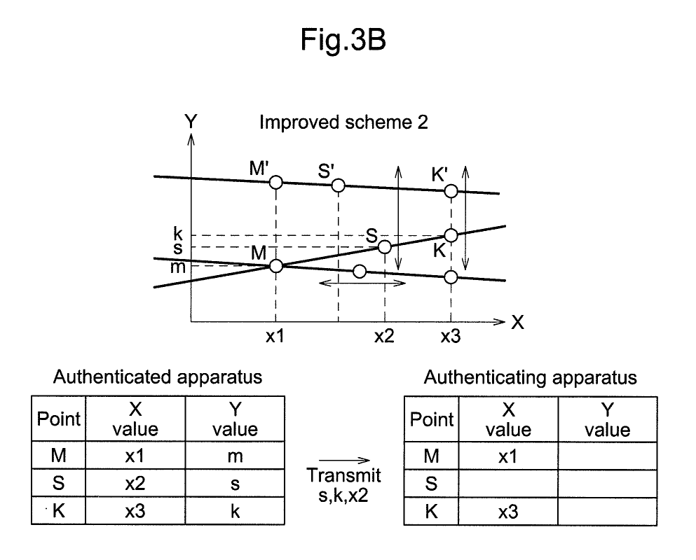

Basic concepts of secret authentication according to the presents invention are described with reference to FIGS. 2A to 4. FIGS. 2A to 3B illustrate one certain scheme of the secret authentication of the present invention. In the scheme, a type of assumed function is a linear function having X and Y as variables, more specifically, a function expressed as Y=aX+b (where a and b are coefficients). Authentication data m is provided as a Y value of point M (x1, m), where an X value is x1 on a linear function passing through point S (x2, s) and point K (x3, k). The linear function is primarily defined by function data x2, x3, s, and k. Authentication data m is thus obtained from the function data and rule data x1, which specifies authentication data m from the linear function.

Authentication data m is specified by rule data x1 herein. Specifically, authentication data m is an intersection point of the linear function and x=x1, the linear function being primarily defined by function data x2, x3, s, and k. Alternatively, authentication data m may be specified as point M′ intersecting with another linear function connecting M′, S′ and K in FIG. 2A.

Function data x2, x3, s, and k and rule data x1 are positioned as distributed data that distributedly define authentication data m. Unless all distributed data x1, x2, x3, s, and k are provided, authentication data m cannot be obtained.

A portion of distributed data x1 to x3, s, and k, are shared between client 1 and server 2 before or after authentication in a procedure different from a procedure performed at the time of authentication. When client 1 requests server 2 for authentication, client 1 generates the distributed data, which are not shared with server 2, from authentication data m, and transmits the generated distributed data to server 2. Then, server 2 obtains authentication data m from the distributed data stored therein and the distributed data received from client 1.

In scheme 1 shown in FIG. 2A, only distributed data s, which is a Y value of one point S, is transmitted from client 1 to server 2; and remaining distributed data x1 to x3 and k are shared between client 1 and server 2. Remaining distributed data x1 to x3 and k are fixed values, and at least a portion of the data is kept secret. In this case, only distributed data s changes according to authentication data m.

In an improvement of scheme 1 shown in FIG. 2B, distributed data s and x2 are transmitted, which are an X value and a Y value of one point S; and remaining distributed data x1, x3, and k are shared between client 1 and server 2. Remaining distributed data x1, x3, and k are fixed values, and at least a portion of the data is kept secret. In this case, distributed data x2 is any value, such as, for example, generated from a random number. Distributed data s is defined such that point S is provided on a line passing through two points M and K.

In scheme 2 shown in FIG. 3A, distributed data s and k are transmitted, which are Y values of two points S and K, respectively; and remaining distributed data x1 to x3 are shared between client 1 and server 2. Remaining distributed data x1 to x3 are fixed values, and at least a portion of the data is kept secret. In this case, distributed data s is any value, such as, for example, generated from a random number. Distributed data k is defined as a Y value of point K, where an X value is x3 on a line passing through two points M and S.

In an improvement of scheme 2 shown in FIG. 3B, distributed data s, x2, and k are transmitted, which are an X value and a Y value of point S and a Y value of point K, respectively; and remaining distributed data x1 and x3 are shared between client 1 and server 2. Remaining distributed data x1 and x3 are fixed values, and at least a portion of the data is kept secret. In this case, distributed data s and x2 are any values, such as, for example, generated from random numbers. Distributed data k is defined as a Y value of point K, where an X value is x3 on the line passing through two points M and S.

In scheme 1 of FIG. 2A, the same value is transmitted every time for same authentication data m. Thus, an intermediary can easily spoof using the value. In the improvement of scheme 1 of FIG. 2B, when authentication is performed for a plurality of times, point S (x2, x) is aligned on the same line for same client 1. Thus, spoofing is possible once distributed data s and x2 are determined on any points of the line.

In scheme 2 of FIG. 3A, a gradient of the line passing through S and K changes at every authentication. When authentication is performed for a plurality of times, however, point M (x1, m), which specifies authentication data m, appears as an intersection point of the line passing through points S and K. Thus, authentication data m may be detected. The same issue arises in the improvement of scheme 2 of FIG. 3B.

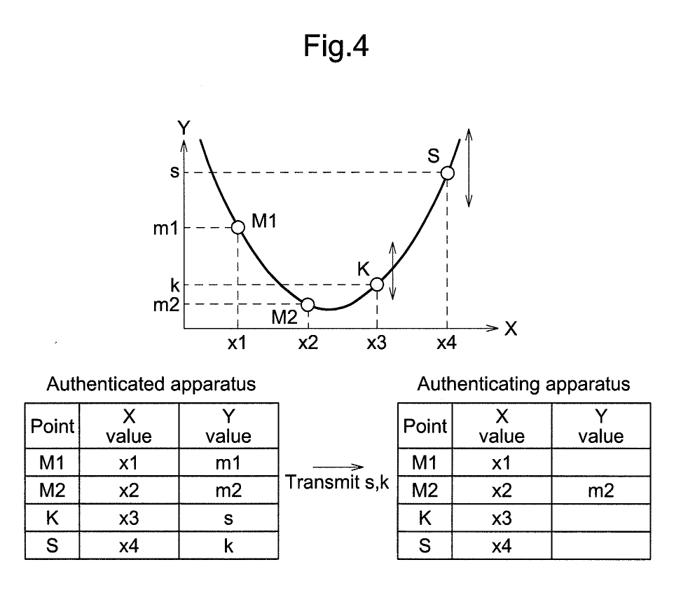

FIG. 4 illustrates a scheme of the secret authentication according to the present invention in another example. A type of function assumed herein is a quadratic curve having X and Y as variables, more specifically, a function expressed as Y=cX²+dX+e (where c, d, and e are coefficients). When authentication data m1 is provided as a Y value of point M1 (x1, m1), where an X value is x1 on a quadratic curve passing through point M2 (x1, m2), point K (x3, k), and point S. (x4, s), coefficients c, d, and e are obtained from function data x2 to x4, m2, s, and k, and thus the function expression of the curve is primarily defined. Then, authentication data m is obtained from the function data and rule data x1, which specifies authentication data m1 from the function expression of the curve.

Function data x2 to x4, m2, s, and k and rule data x1 are positioned as distributed data that distributedly define authentication data m1. Unless all distributed data x1 to x4, m2, s, and k are provided, authentication data m1 cannot be obtained.

A portion of distributed data x1 to x4, m2, s, and k are shared between client 1 and server 2 before or after authentication in a procedure different from a procedure performed at the time of authentication. When client 1 requests server 2 for authentication, client 1 generates the distributed data unshared with server 2 from authentication data m, and transmits the generated distributed data to server 2. Then, server 2 can obtain the authentication data from the distributed data stored therein and the distributed data received from client 1. 100591 Similar to the examples where the linear function is used in FIGS. 2A to 3B, a variety of combinations are considered for settings of the distributed data shared between client 1 and server 2, and of the distributed data to be transmitted from client 1 to server 2 at the time of authentication. Even with the scheme employing the quadratic function, however, a possibility of spoofing or stealing of authentication data by an intermediary cannot be eliminated, similar to the examples of FIGS. 2A to 3B.

Thus, instead of transmitting the distributed data to server 2 as they are, client 1 generates and transmits to server 2 verification data, which is distributed data processed with a predetermined calculation, more specifically, a calculation difficult for a third party to perform a back calculation. Server 2 then verifies authenticity of client 1, based on the authentication data stored in server 2 and the verification data received from client 1. Since a portion of the distributed data to be transmitted is processed with a calculation difficult for a third party to perform a back calculation, even when an intermediary intervening in communication between an authenticated apparatus and an authenticating apparatus intercepts the distributed data and the verification data transmitted from the authenticated apparatus to the authenticating apparatus, it is difficult for the intermediary to perform a back calculation of the authentication data. Since the contents of the distributed data, which is a source of the verification data, are unknown to the intermediary, and thus not all distributed data are provided, it is difficult for the intermediary to presume the authentication data. Thereby, improper authentication can surely be prevented, and thus high secrecy can be ensured. Further, using a low degree function, such as a linear function, reduces calculation load. A low speed calculation device will thus suffice, and the cost can be reduced.

<Example of Using Control Data in Secret Distribution Scheme>

As an example in which scheme 2 employing the quadratic function shown in FIG. 4 is applied, a specific configuration of the present invention is explained below with reference to FIGS. 1, 4, and 5. A type of assumed function that client 1 and server 2 in FIG. 1 or 4 share is a quadratic curve having X and Y as variables, more specifically, a function expressed as Y=cX²+dX+e (where c, d, and e are coefficients). Client 1 and server 2 in FIG. 4 share in advance a portion of distributed data x1, x2, x3, and x4. Further, distributed data s is also shared, which client 1 arbitrarily generates using a random number and transmits to server 2. In addition, it is assumed that client 1 of the present embodiment stores authentication data m in authentication data memory 101. Authentication data m is delivered from a user of client 1 to an administrator of server 2, as shown in FIG. 1 or 5, in a separate highly confidential method, such as, for example, mail and the like. Authentication data m is then registered in server 2 as well in advance. Thus, client 1 and server 2 further share authentication data m, which is also the distributed data. Of the shared distributed data, coefficients c, d, and e of function Y=cX²+dX+e of the curve passing through three points M1, M2, and S are obtained from distributed data x1, x2, x4, m1, m2, and s. Thus, function Y=cX²+dX+e of the curve is primarily defined on both client 1 and server 2. Distributed data x1, which is an X value of authentication data m1, is referred to particularly as “rule data.” The rule data is differentiated because x1 is special distributed data for obtaining authentication data m1 using function Y=cX²+dX+e of the present embodiment, or a determining value specifying authentication data m from the function. Subsequently, client 1 defines distributed data k as a Y value of point K, where an X value is x3 on curve Y=cX²+dX+e passing through three points M1, M2 and S. More specifically, client 1 and server 2 shown in FIG. 1 or 5 share distributed data x1 to x4 and authentication data m1, which is also the distributed data and indicates authenticity of client 1 or a user thereof. Client 1 shown in FIG. 1 or 5 transmits to server 2, distributed data m2, s, and k, which are Y values of three points M2, S, and K, respectively, as shown in FIG. 4. In the process, client 1 in FIG. 1 or 5 first performs for distributed data k a predetermined calculation process, more specifically, calculation process F difficult for a third party to perform a back calculation, for example, and then transmits the data as verification data F(k). Server 2 is also capable of performing calculation process F difficult for a third party to perform a back calculation, identical to the calculation process of client 1. Based on distributed data x1, x2, x4, m1, m2, and s shown in FIG. 4, which are shared with client 1 in advance, server 2 obtains coefficients c, d, and e of function Y=cX²+dX+e of the curve passing through three points M1, M2 and S. Then, server 2 assigns x3 to X of obtained function Y=cX²+dX+e of the curve, and thus independently obtains k, which is the Y value of the function. Thereafter, server 2 performs for obtained k, calculation process F difficult for a third party to perform a back calculation. When determining that the calculation result is identical to verification data F(k) transmitted from client 1, server 2 can confirm that client 1 is a proper party. The processes above illustrate a basic concept of the present invention using FIG. 4.

The basic concept of the present invention using FIG. 4 above is illustrated in a specific configuration example of FIG. 5. FIG. 5 is a block diagram illustrating a first embodiment of the server and the client shown in FIG. 1. Authentication data memory 101 secretly stores authentication data m1, which is entered by a user of client 1 and indicates authenticity of the apparatus. Distributed data memory 102 secretly stores distributed data x1 to x4, which are shared in advance between client 1 and server 2. Random number generator 103 generates distributed data s using random numbers. Distributed data s is then transmitted to server 2. Distributed data generator 104 generates distributed data m2, which contains predetermined control data. Authentication data memory 101 stores authentication data m1. Function processor 105 is assumed to perform processes based on a specific type of function. In the present embodiment using FIGS. 4 and 5, function processor 105 processes an X value and a Y value based on a quadratic function expressed as Y=cX²+dX+e (where c, d, and e are coefficients). Thereby, coefficients c, d, and e are obtained from distributed data x1, x2, and x4 (x1 is also the “rule data”) stored in distributed data memory 102, authentication data m stored in authentication data memory 101, and distributed data s generated by random number generator 103. Function Y=cX²+dX+e is thus primarily defined. Assigning distributed data x3, which is stored in distributed data memory 102, to the X value provides distributed data k, which is the Y value. Verification data generator 106 converts distributed data k calculated by function processor 105 into verification data F(k), by using a one-way function. When requesting server 2 for authentication, client 1 transmits to server 2 verification data F(k) obtained in verification data generator 105 and distributed data s generated by random number generator 103.

Distributed data m2 is generated by distributed data generator 104 from control data T. Control data T includes information related to time when a predetermined process operation is performed on client 1 (time information); information related to the number of access from client 1 to server 2, more specifically, the number of authentication for which client 1 requests server 2 (access count information); and information related to authority associated with use of server 2 by client 1 (access authorization information). Distributed data m2 may be control data T itself. When control data T is time information expressed in UTC (Coordinated Universal Time), for example, data converted into system time starting on Jan. 1, 1970 in the computer may be used as distributed data m2. In other words, distributed data m2 may be control data T processed into a separate format.

The access authorization information herein refers to a time period during which access is allowed, such as, for example, a time period when server access authorization is temporarily transferred to another person. Access after successful authentication may be limited, by adding information setting a range of authorization, such as access limit after authentication, including whether or not a person can provide approval, browse or edit data, and the like.

A typical one-way function, such as a hash function and the like, can be used as a one-way function employed in verification data generator 106 for a calculation process difficult for a third party to perform a back calculation. In light of one-wayness sufficient for practical use, however, a square function is suitable with low calculation load, which allows application to simple devices having merely a low speed calculation function (an RFID tag and the like).

Authentication data storage 201 of server (authenticating apparatus) 2 stores authentication data m1 for each of a plurality of clients 1, including authentication data m indicating authenticity of each of clients 1. Authentication data m is delivered from a user of client 1 to an administrator of server 2 in a separate highly confidential method, such as, for example, mail and the like; and then is stored in server 2 in advance. Distributed data memory 202 stores distributed data x1 to x4, which are shared in advance between client 1 and server 2. Function processor 203 is assumed to perform processes based on a type of function identical to the function used in function processor 105 of client 1. In the present embodiment using FIGS. 4 and 5, function processor 203 processes an X value and a Y value based on the quadratic function expressed as Y=cX²+dX+e (where c, d, and e are coefficients). Thereby, coefficients c, d, and e are obtained from distributed data x1, x2, and x4 (x1 is also the “rule data”) stored in distributed data memory 202, authentication data m1 stored in authentication data storage 201, and distributed data s and m2 received from client 1. Function Y=cX²+dX+e is thus primarily defined. Assigning distributed data x3, which is stored in distributed data memory 202, to the X value provides distributed data k, which is the Y value. Verification data generator 204 converts distributed data k calculated by function processor 203 into verification data F(k), by using a one-way function identical to the one-way function employed in verification data generator 106 of client 1. Checker 205 compares verification data F(k) received from client 1 against verification data F(k) calculated by verification data generator 204, and thus verifies authenticity of client 1.

Server 2 sequentially reads out authentication data from authentication data storage 201. When checker 205 finds in authentication data storage 201 of server 2, authentication data m1 having verification data F(k), which is calculated by verification data generator 204, identical to verification data F(k) received from client 1, authentication is deemed to have succeeded. When the data are not identical, server 2 reads out subsequent authentication data from authentication data storage 201 and performs the similar process described above. When no authentication data m1 having the identical data is found in authentication data storage 201, authentication is deemed to have failed.

Further, server 2 has data extractor 206 and authentication determinator 207. Data extractor 206 extracts control data T from distributed data m2 received from client 1. Authentication determinator 207 determines whether or not to authorize client 1 based on control data T obtained in data extractor 206. When control data T obtained in data extractor 206 is data associated with authentication, authentication determinator 207 of server 2 compares the data with control data T stored therein. When there is a difference beyond a predetermined acceptable range, server 2 denies authentication even when the data is matched in checker 205.

When the data is matched in checker 205, and control data T relates to access authorization, server 2 allows access within the limit.

In this case, server 2 limits authentication based on the time provided in the time information in control data T. For example, when server 2 compares the time information in control data T received from client 1 against the current time, and determines that a predetermined time or more has elapsed, server 2 denies authentication. Further, server 2 limits authentication based on the number of access provided in the access count information in control data T. For instance, when server 2 compares the access count information in control data T received from client 1 against the current access count, and determines that the count is out of a predetermined range, server 2 denies authentication. Server 2 can also limit authentication based on access authorization provided in the access authorization information in the control data.

In the configuration, even when intermediary 3 shown in FIG. 1 knows function data x1 to x4 shown in FIG. 5, and intercepts distributed data m2 and s and verification data F(k) transmitted from client 1 to server 2 shown in FIG. 5, for instance, more specifically, intermediary 3 shown in FIG. 1 knows all the function data shown in FIG. 5, except k, and F(k), intermediary 3 shown in FIG. 1 cannot calculate k from F(k) shown in FIG. 5, and thus cannot obtain authentication data m. In addition, function data s of the present embodiment is a random number generated by random number generator 103 and changes at every authentication request from client 1. Thus, when client 1 and server 2 use common quadratic function Y=cX²+dX+e shown in FIG. 4, for example, point S shifts toward a Y axis with respect to points M1 and M2 as fixed points, along with the change of Y value s of point S at every authentication request from client 1. Then, coefficients c, d, and e of function Y=cX²+dX+e change, and a gradient and an intercept change. Accordingly, point K, which has function data k as a Y value, also shifts toward the Y axis, and thus function data k in FIG. 5 changes at every authentication request from client 1. Thereby, verification data F(k) also changes at every authentication request from client 1, thus making it further difficult to specify distributed data k for a third party intervening in communication between client 1 and server 2.

When control data T is the time information, the distributed data exchanged between client 1 and server 2 changes according to the change of contents of control data T as time elapses. Thus, intermediary 3 shown in FIG. 1 cannot receive authentication improperly, by copying communication between client 1 and server 2 and using the distributed data used in the communication. Thereby, server 2 shown in FIGS. 1 and 5 can prevent retry attacks from intermediary 3 shown in FIG. 1. When intermediary 3 tampers with control data T shown in FIG. 5, the data will be inconsistent with the other distributed data. Thus, an operator of intermediary 3 cannot tamper with the value. This also applies to a case where control data T shown in FIG. 5 is access count information.

When control data T is the access count information, server 2 can limit access thereto depending on the contents.

Control data T is important in order to protect a user from an improper act of a third party. In addition, control data T allows very effective password control, such as, having another person work on someone else's behalf by transferring distributed data and verification data containing time and access limits.

Further, ID data identifying authentication data m1 of client 1 may be transmitted from client 1 to server 2, along with verification data F(k) and random number data m2 and s. Server 2 then reads out from authentication data storage 201, authentication data m1 corresponding to the ID data received from client 1. Thus, a comparison process at checker 205 is performed only once, and the process is simplified. With the configuration above, similar to the explanation in FIG. 5, even when an intermediary intervening in communication between the authenticated apparatus and the authenticating apparatus intercepts data transmitted from the authenticated apparatus to the authenticating apparatus, the intermediary cannot obtain the authentication data, and thus high secrecy can be ensured. Further, a reduced calculation load allows use of low speed calculator, thus reducing the cost.

<Alternative Example of Using Control Data in Secret Distribution Scheme>

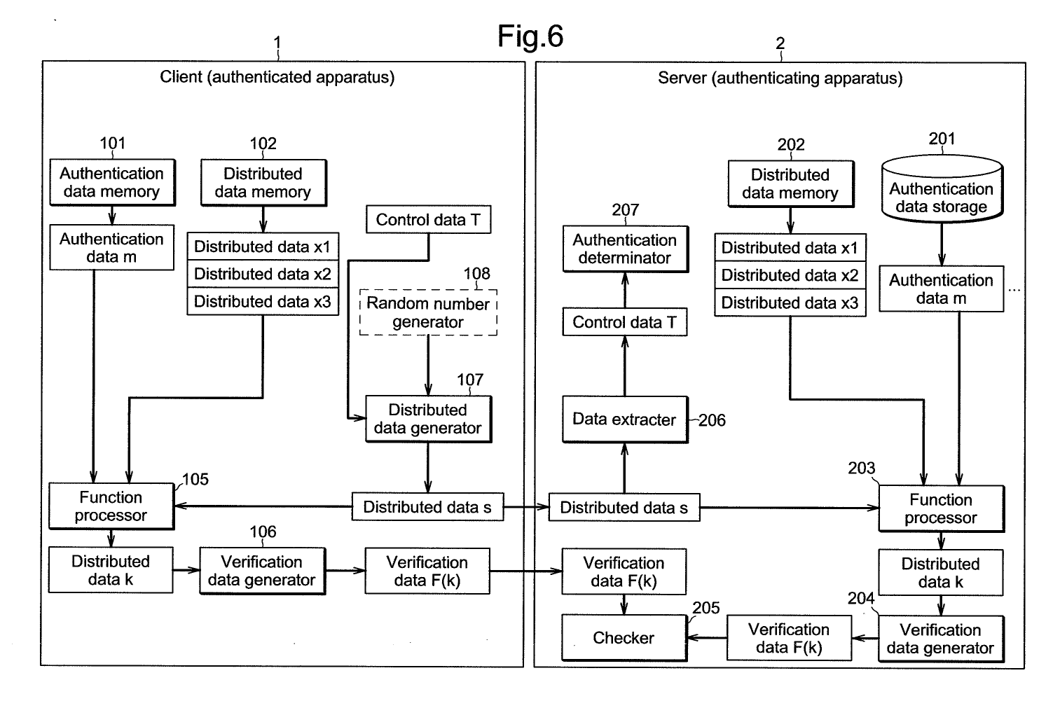

FIG. 6 is a block diagram illustrating a second embodiment of the server and the client shown in FIG. 1. Scheme 2 using the linear function shown in FIG. 3A is employed herein. A portion of distributed data x1 to x3 is shared between client 1 and server 2.

Client 1 secretly stores distributed data x1 to x3 in distributed data memory 102. Client 1 has distributed data generator 107 that generates distributed data s, which contains predetermined control data T. Verification data F(k) obtained in verification data generator 106 and distributed data s obtained in distributed data generator 107 are transmitted to server 2.

Server 2 extracts in data extractor 206, control data T from distributed data s received from client 1; and determines in authentication determinator 207, whether or not authentication is granted based on the control data obtained in data extractor 206.

When distributed data s is a fixed value, distributed data generator 107 of client 1 may add predetermined control data T to random number data generated by random number data generator 108, and thereby generate distributed data s. With the configuration above, similar to the explanation in FIG. 5, even when an intermediary intervening in communication between the authenticated apparatus and the authenticating apparatus intercepts data transmitted from the authenticated apparatus to the authenticating apparatus, the intermediary cannot obtain the authentication data, and thus high secrecy can be ensured. Further, a reduced calculation load allows use of low speed calculator, thus reducing the cost.

<Example of Using Public Key Data in Secret Distribution Scheme>

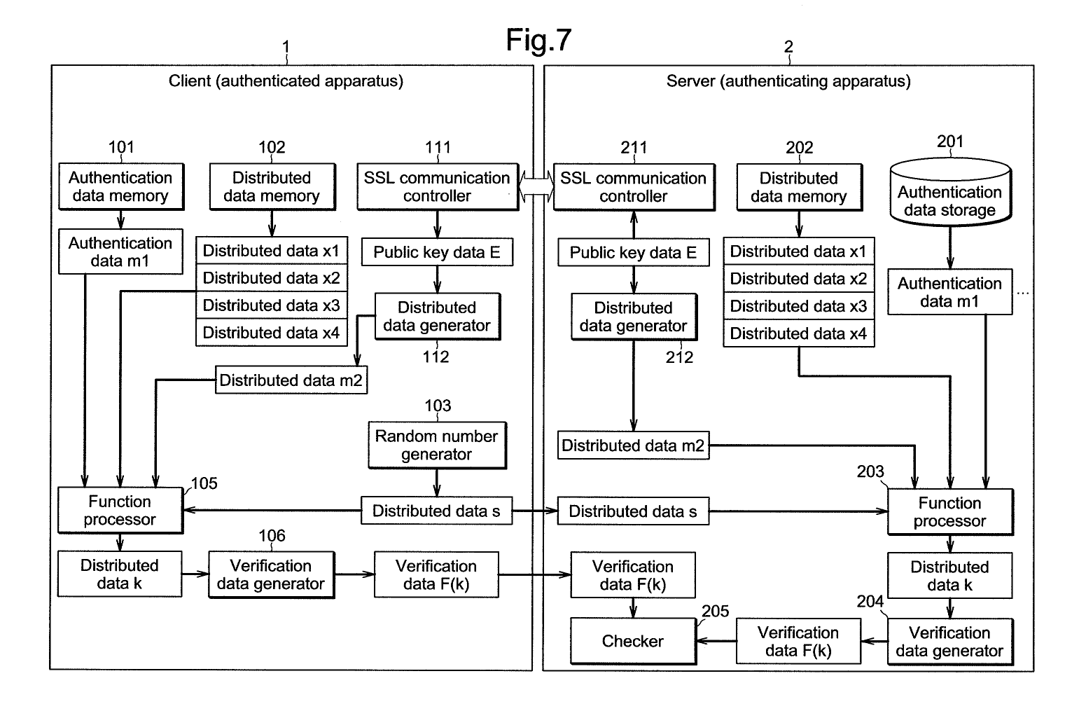

FIG. 7 is a block diagram illustrating a third embodiment of the server and the client shown in FIG. 1. Similar to the example of FIG. 5, the quadratic function shown in FIG. 4 is employed herein. A portion of distributed data x1 to x4 shown in FIG. 7 is shared between client 1 and server 2. The configuration shown in FIG. 7 is different from that in FIG. 5 in that, while distributed data m2 in FIG. 5 is generated from control data T, distributed data m2 in FIG. 7 is generated from public key data E stored in server 2. Thus, client 1 and server 2 performs SSL communication. In a negotiation process of SSL communication, a server certificate, which contains public key data E of server 2, is transferred to client 1. Other components in the configuration are the same as those in the example of FIG. 5.

In FIG. 7, client 1 includes SSL communication controller 111 and distributed data generator 112, which generates distributed data m2 based on public key data E of server 2 obtained therefrom through SSL communication controller 111. Function processor 105 calculates distributed data k from distributed data m2 obtained herein; authentication data m1 stored in authentication data memory 101; distributed data x1 to x4 stored in distributed data memory 102; and distributed data s generated by random number generator 103.

Server 2 includes SSL communication controller 211 and distributed data generator 212, which generates distributed data m2 based on its own public key data E identical to the data transmitted to client 1 through SSL communication controller 211. Function processor 203 calculates distributed data k from distributed data m2 obtained in distributed data generator 212; distributed data x1 to x4 stored in distributed data memory 202; authentication data m1 stored in authentication data storage 201; and distributed data s received from client 1.

In the configuration above, the distributed data exchanged between client 1 and server 2 is generated based on public key data E of server 2. Thus, even when intermediary 3 is present intervening in communication between client 1 and server 2 shown in FIG. 1, intervention of intermediary 3 is revealed, since public key data of intermediary 3 is different from public key data E of server 2 shown in FIG. 7 because of reasons described below. Thus, intermediary attacks are prevented.

More specifically, intermediary 3, which does not know the private key owned by server 2, transmits to client 1 a false server certificate in response to an SSL communication start request from client 1 so as to decrypt encrypted communication data, the false server certificate containing a public key associated with a private key owned by the intermediary. Client 1 calculates verification data based on the false public key contained in the false server certificate.

Meanwhile, server 2 calculates verification data F(k) based on authentic public key data E of server 2. Thus, when checker 205 compares the verification data received from intermediary 3 in FIG. 1 spoofing as client 1 against verification data F(k) calculated by verification data generator 204, in order to verify authenticity of client 1 shown in FIGS. 1 and 7, no matching verification data m1, exist having the identical verification data, and thus verification fails. Thereby, it is revealed that an intermediary is intervening in communication between client 1 and server 2. In the configuration above, even when the intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

Distributed data s herein is generated based on the public key data. Distributed data s may be obtained by converting, using a hash function, server certificate data or public key data received during negotiation in SSL communication. This applies to other embodiments.

<Example of Using Response Data in Secret Distribution Scheme>

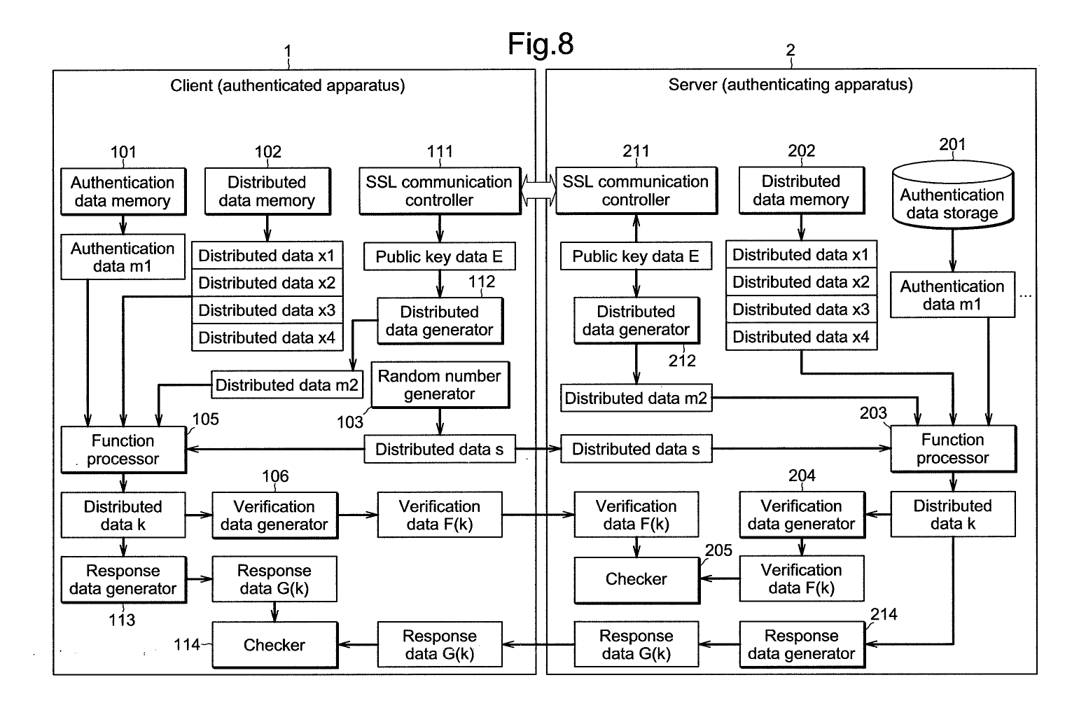

FIG. 8 is a block diagram illustrating a fourth embodiment of the server and the client shown in FIG. 1. A basic configuration is similar to the example of FIG. 7. In FIG. 8, however, server 2 has response data generator 214. When authenticity of client 1 was verified in checker 205 after the processes shown in the example of FIG. 7, response data generator 214 converts distributed data k obtained in function processor 203, by using a one-way function different from a one-way function used in verification data generator 204, and thus obtains response data G(k). Response data G(k) obtained herein is transmitted to client 1.

Client 1 has response data generator 113 and checker 114. Response data generator 113 converts distributed data k obtained in function processor 105, by using a one-way function identical to the one-way function used in response data generator 214 of server 2, and thus obtains response data G(k). Checker 114 compares response data G(k) received from server 2 against response data G(k) obtained in response data generator 113, and thus verifies authenticity of server 2.

In the configuration of FIG. 7, intermediary 3 of FIG. 1 intervening in communication between client I and server 2 cannot transfer to server 2, verification data F(k) received from client 1 shown in FIGS. 1 and 8 as it is. Spoofing is possible, however, when intermediary 3 of FIG. 1 has proper authentication data m1 different from that of client 1 shown in FIGS. 1 and 8. Intermediary 3 of FIG. 1 passes its own public key to client 1 shown in FIGS. 1 and 8, and discards verification data F(k) transmitted from client 1. Then, intermediary 3 generates therein distributed data s from random numbers, and calculates verification data F(k) based on distributed data s and authentic public key data E, which is contained in an authentic server certificate received from server 2. When intermediary 3 transmits to server 2 verification data F(k) and distributed data s, checker 205 of server 2 determines that authentication data m1 exists having verification data F(k) calculated by verification data generator 204 identical to verification data F(k) received from the intermediary, and thus verification succeeds.

In the configuration of FIG. 8, however, spoofing described above can be prevented. Since intermediary 3 of FIG. 1 does not know authentication data m1 of client 1 shown in FIGS. 1 and 8, intermediary 3 cannot generate response data G(k) transmitted from server 2. Even when intermediary 3 of FIG. 1 takes the liberty of generating response data and transmits the data to client 1 as it is, checker 114 of client 1 shown in FIGS. 1 and 8 compares the response data received from intermediary 3 spoofing as server 2 against response data G(k) obtained in client 1, and determines that the data do not match and thus that verification fails. Thereby, it is revealed that an intermediary is intervening in communication between client 1 and server 2.

Similar to the verification data, the response data may be obtained in a calculation process in which distributed data k is converted with a one-way function, such as a hash function, a square function, and the like. It is desired, however, that a calculation method be different from that used in the calculation process obtaining the verification data. Further, the response data may be product data m1×k obtained by multiplying authentication data m1 by distributed data k. In the configuration above, even when the intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Example of Using Network Address in Secret Distribution Scheme>

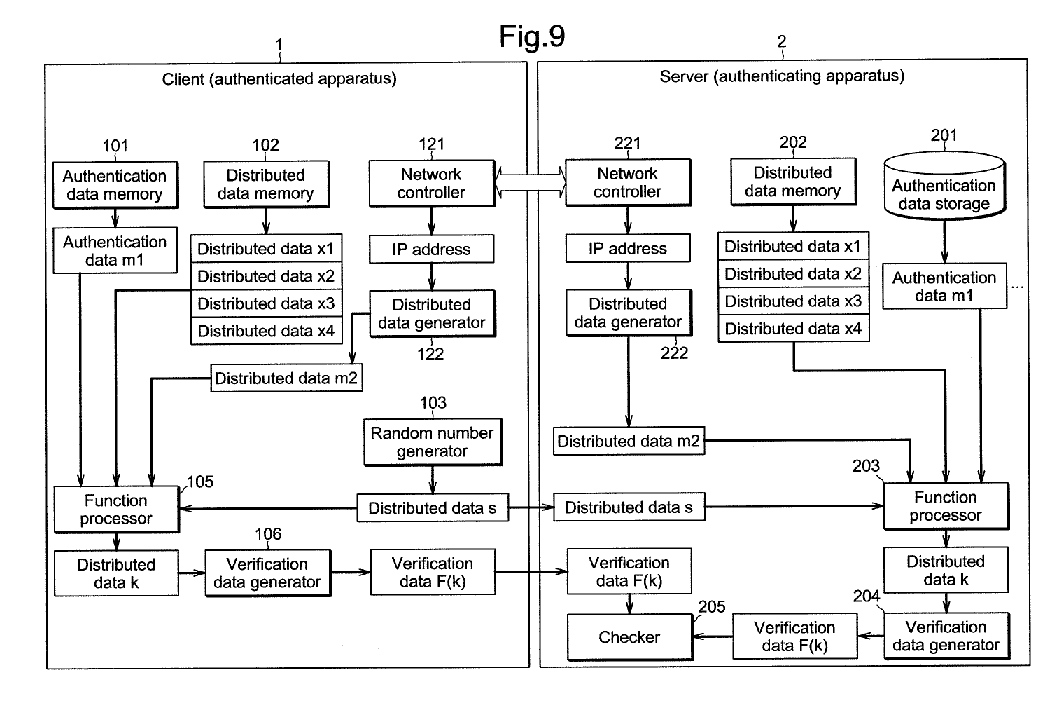

FIG. 9 is a block diagram illustrating a fifth embodiment of the server and the client shown in FIG. 1. A basic configuration is similar to the example of FIG. 7. In FIG. 9, however, distributed data m2 is generated from an IP address (network address) of server 2, whereas distributed data m2 is generated from a public key in FIG. 7. Client 1 has distributed data generator 122, which generates distributed data m2 based on an IP address (network address) of server 2 obtained therefrom through network communication controller 121. Distributed data m2 obtained herein is transmitted to function processor 105. Server 2 has distributed data generator 222, which generates distributed data m2 based on its own IP address stored in network communication controller 221. Distributed data m2 obtained herein is transmitted to function processor 203. Other components in the configuration are the same as those in the example of FIG. 7.

Although an IP address is used as a network address herein, a MAC address and others may be used instead.

Contrary to the example above, client 1 may generate distributed data m2 based on its own network address, and server 2 may generate distributed data m2 based on the network address of client 1. In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Example of Using Linear Function in Secret Distribution Scheme>

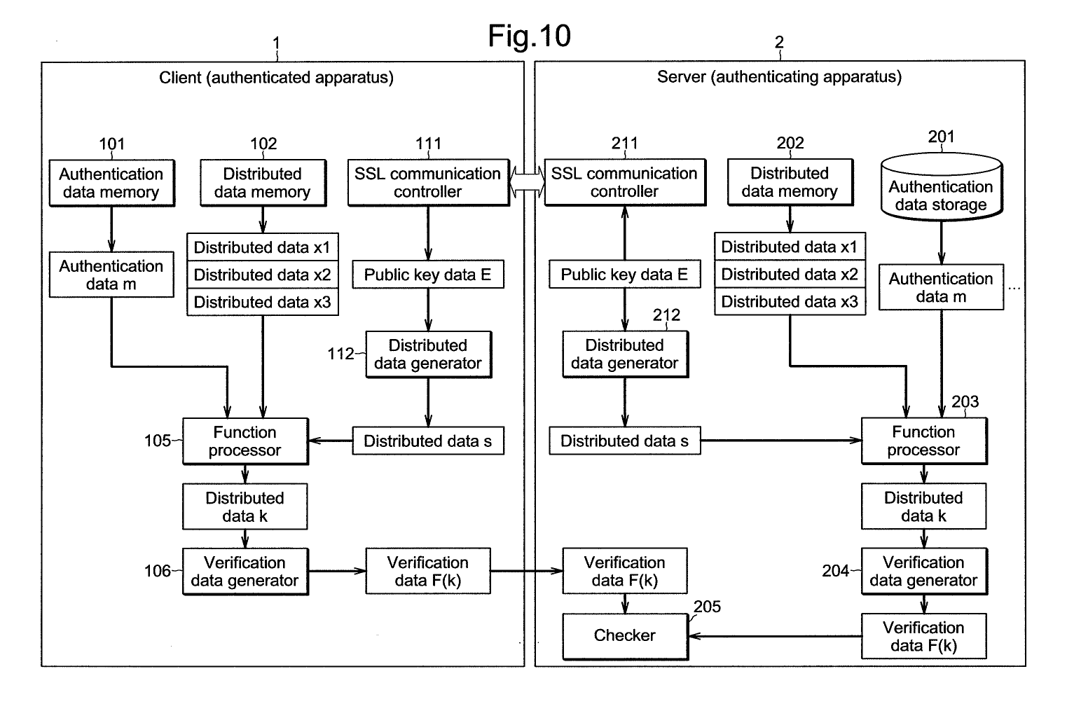

FIG. 10 is a block diagram illustrating a sixth embodiment of the server and the client shown in FIG. 1. A basic configuration is similar to the example of FIG. 7. In FIG. 10, however, scheme 2 of FIG. 3A using the linear function is employed, instead of the quadratic function of FIG. 4 employed in FIG. 7. A portion of distributed data x1 to x3 is shared between client 1 and server 2.

Function processor 105 of client 1 calculates distributed data k from distributed data s obtained in distributed data generator 112, based on authentication data m stored in authentication data memory 101, distributed data x1 to x3 stored in distributed data memory 102, and public key data E of server 2. Only verification data F(k) obtained in verification data generator 106 is transmitted to server 2.

Function processor 203 of server 2 calculates distributed data k from distributed data s obtained in distributed data generator 212, based on distributed data x1 to x3 stored in distributed data memory 202, authentication data m1 stored in authentication data storage 201, and public key data E of server 2.

It is desired that random number data be added to distributed data s. In this case, client 1 needs to transmit distributed data s to server 2. In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Alternative Example of Using Linear Function in Secret Distribution Scheme>

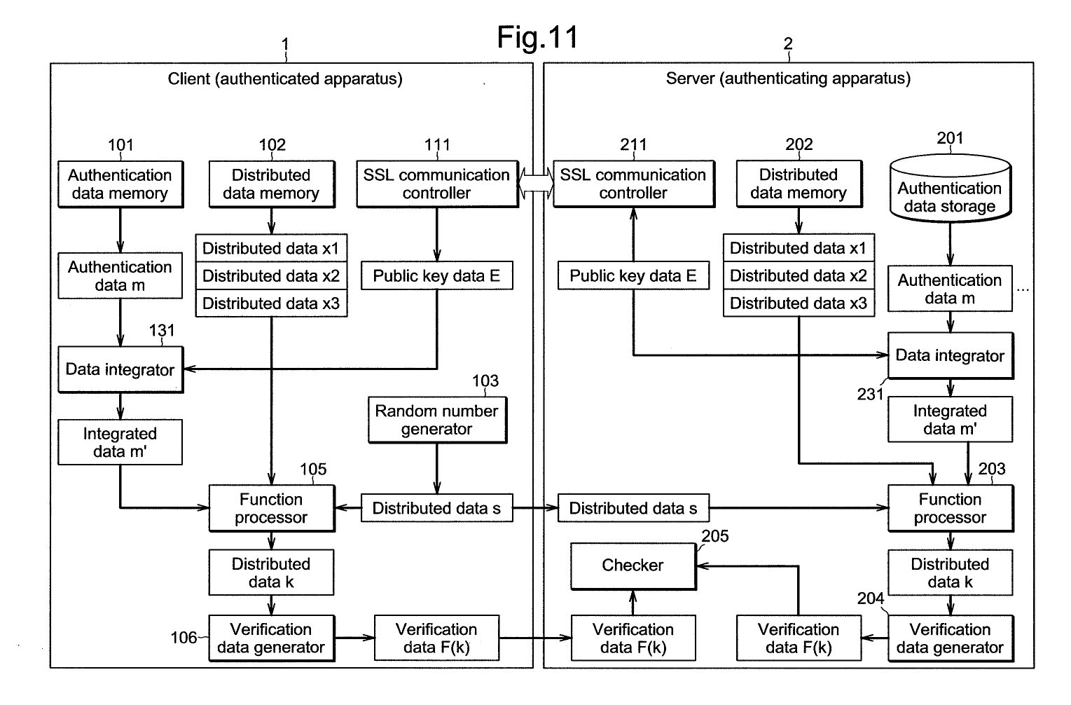

FIG. 11 is a block diagram illustrating a seventh embodiment of the server and the client shown in FIG. 1. A basic configuration is similar to the example of FIG. 7. In FIG. 11, however, client 1 has data integrator 131, which integrates authentication data m and public key data E of server 2, authentication data m being stored in authentication data memory 101, public key data E being obtained from server 2 through SSL communication controller 111. Function processor 105 calculates distributed data k from integrated data m′ obtained herein, distributed data x1 to x3 stored in distributed data memory 102, and distributed data s obtained in random number generator 103.

Server 2 has data integrator 231, which integrates authentication data m stored in authentication data storage 201 and public key data E of server 2. Function processor 203 calculates distributed data k from integrated data m′ obtained herein, distributed data x1 to x3 stored in distributed data storage 202, and distributed data s received from client 1. In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Example of Combining Control Data and Unique Data in Secret Distribution Scheme>

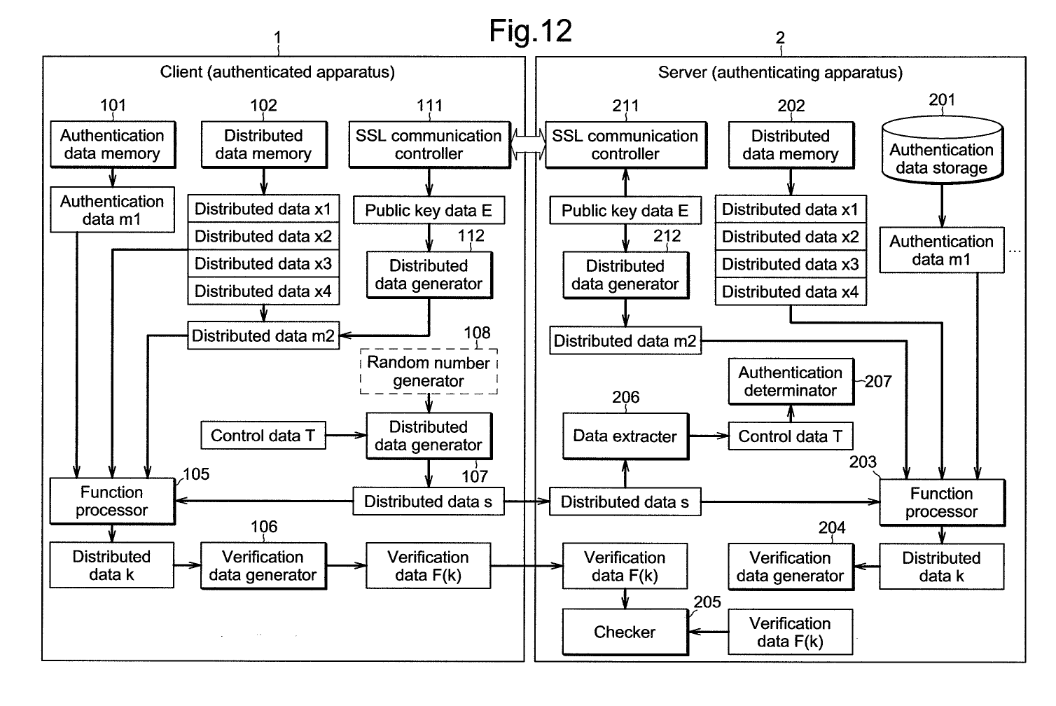

FIG. 12 is a block diagram illustrating an eighth embodiment of the server and the client shown in FIG. 1. Similar to the example of FIG. 7, distributed data generator 112 of client 1 generates distributed data m2 based on public key data E of server 2 obtained therefrom through SSL communication controller 111. Similar to the example of FIG. 6, distributed data generator 107 generates distributed data s containing predetermined control data T. Distributed data s obtained in distributed data generator 107 is transmitted to server 2 along with verification data F(k). Specifically, control data T and public key E of server 2, which is unique data, are combined.

Similar to the example of FIG. 7, distributed data generator 212 of server 2 generates distributed data m2 based on its own public key data E, which is identical to the data transmitted to client 1 through SSL communication controller 211. Similar to the example of FIG. 6, data extractor 206 extracts control data T from distributed data s received from client 1. Authentication determinator 207 then determines whether to authenticate client 1 based on the control data obtained in data extractor 206. When distributed data s is a fixed value, distributed data generator 107 of client 1 may generate distributed data s by adding predetermined control data T to random number data generated by random number generator 108. In the configuration above, even when an intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Alternative Example of Combining Control Data and Unique Data in Secret Distribution Scheme>

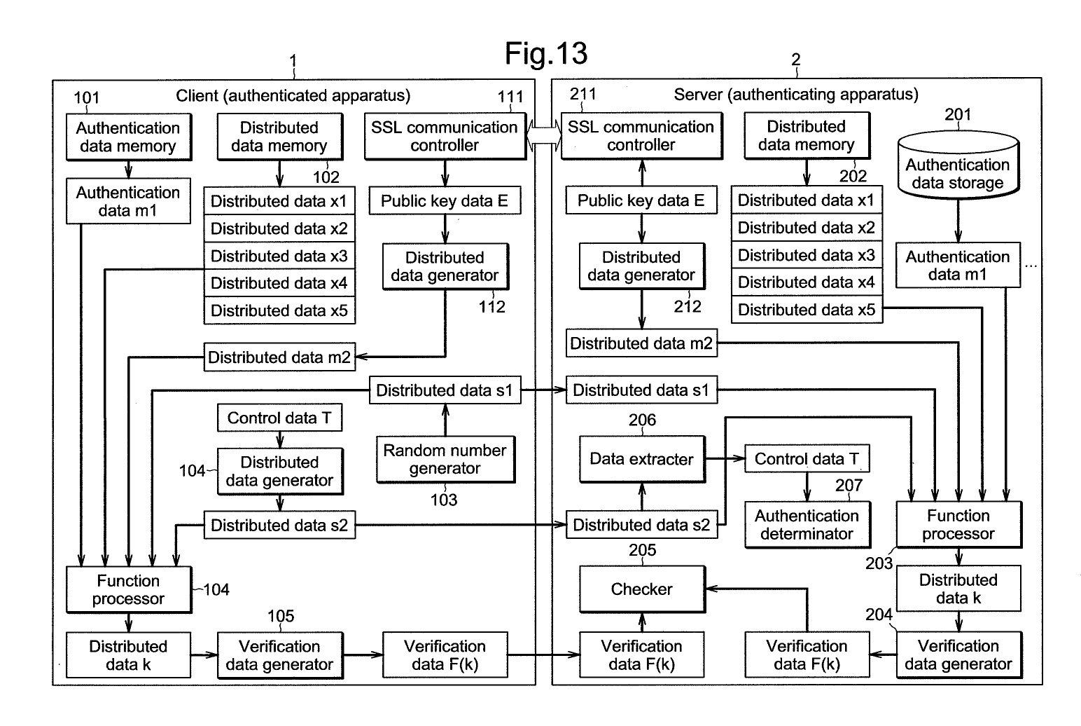

FIG. 13 is a block diagram illustrating a ninth embodiment of the server and the client shown in FIG. 1. A cubic function is employed herein, and a portion of distributed data x1 to x5 are shared between client 1 and server 2. The distributed data correspond as follows: (x1, m1), (x2, m2), (x3, k), (x4, s1), and (x5, s2).

Similar to the example of FIG. 7, distributed data generator 112 of client 1 generates distributed data m2 based on public key data E of server 2 obtained therefrom through SSL communication controller 111. Similar to the example of FIG. 5, random number generator 103 generates distributed data s1 from random numbers. Distributed data generator 104 generates distributed data s2 containing predetermined control data. Then, distributed data s1 obtained in random number generator 103 and distributed data s2 obtained in distributed data generator 104 are transmitted to server 2 along with verification data F(k).

Similar to the example of FIG. 7, distributed data generator 212 of server 2 generates distributed data m2 based on its own public key data E, which is identical to the data transmitted to client 1 through SSL communication controller 211. Similar to the example of FIG. 5, data extractor 206 extracts the control data from distributed data m2 received from client 1. Authentication determinator 207 then determines whether or not authentication is granted based on the control data obtained in data extractor 206. In the configuration above, even when the intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Example of Reverse Authentication in Secret Distribution Scheme>

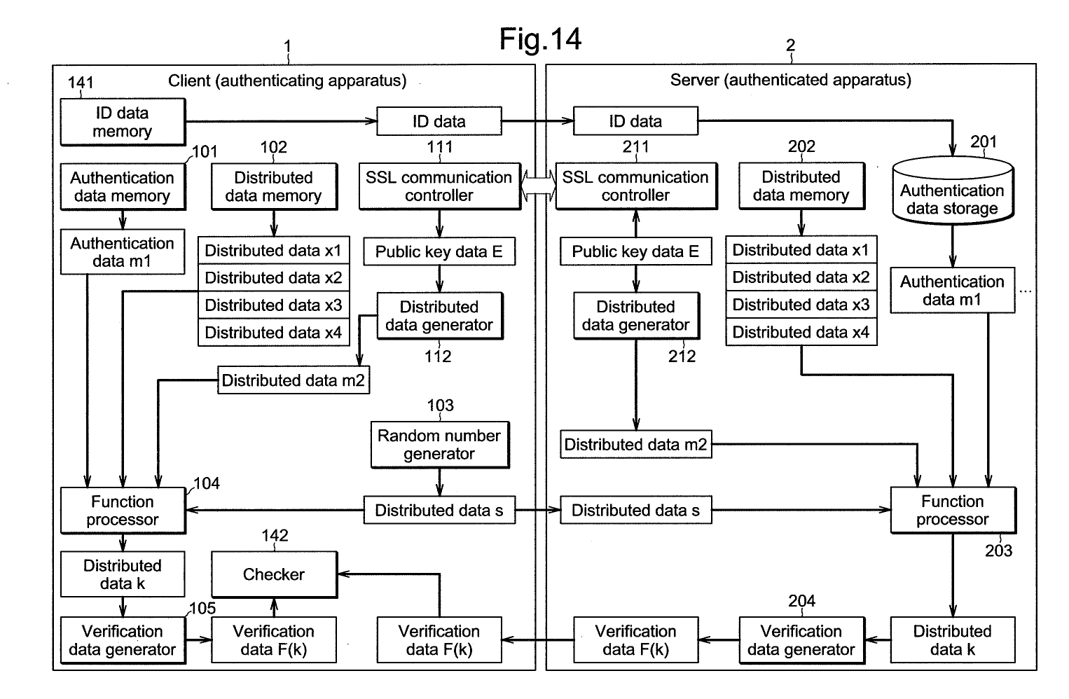

FIG. 14 is a block diagram illustrating a tenth embodiment of the server and the client shown in FIG. 1. Contrary to the example of FIG. 7, client 1 verifies authenticity of server 2. Thus, client 1 is an authenticating apparatus, and server 2 is an authenticated apparatus.

Client (authenticating apparatus) 1 has ID data memory 141, which stores ID data identifying its own authentication data m1. The ID data and distributed data s obtained in random number generator 103 are transmitted to server 2.

Server (authenticated apparatus) 2 retrieves authentication data m1 of client 1 from authentication data storage 201 based on the ID data received from client 1. Function processor 203 calculates distributed data k from authentication data m1 retrieved from authentication data storage 201, distributed data x1 to x4 stored in distributed data memory 202, distributed data m2 obtained in distributed data generator 212, and distributed data s received from client 1. Verification data generator 204 converts distributed data k obtained in function processor 203 by using a one-way function, and thus obtains verification data F(k). Verification data F(k) is transmitted to client 1.

Client 1 has checker 142, which compares verification data F(k) received from server 2 against verification data F(k) calculated by verification data generator 105, and thus verifies authenticity of server 2.

When intermediary 3, as shown in FIG. 1, intervenes in communication between client 1 and server 2, intermediary 3 transmits to client 1 a false server certificate in response to an SSL communication start request from client 1 shown in FIGS. 1 and 14. Client 1 generates distributed data s from random numbers, and transmits to intermediary 3 of FIG. 1 distributed data s and the ID data.

Intermediary 3 of FIG. 1 transmits to server 2 the ID data obtained from client 1 shown in FIGS. 1 and 14 as it is, or ID data corresponding to its own authentication data. Server 2 calculates verification data F(k) based on authentication data m1 of client 1 or intermediary 3 of FIG. 1 corresponding to the ID data received from the intermediary, and on its own authentic public key data E. Server 2 then transmits verification data F(k) to intermediary 3 of FIG. 1. Since intermediary 3 does not know authentication data m1 of client 1 shown in FIGS. 1 and 14, intermediary 2 can only transmit to client 1 verification data F(k) transmitted from server 2 as it is.

Checker 142 of client 1 compares verification data F(k) received from intermediary 3 against verification data calculated by verification data generator 106. In contrast to client 1, in which the verification data is obtained based on false public key data contained in the false server certificate issued by the intermediary of FIG. 1, server 2 shown in FIGS. 1 and 14 obtains verification data F(k) based on its own authentic public key data E. Thus, verification fails in checker 142, and it is revealed that an intermediary is intervening in communication between client 1 and server 2. In the configuration above, even when the intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<Alternative Example of Reverse Authentication in Secret Distribution Scheme>

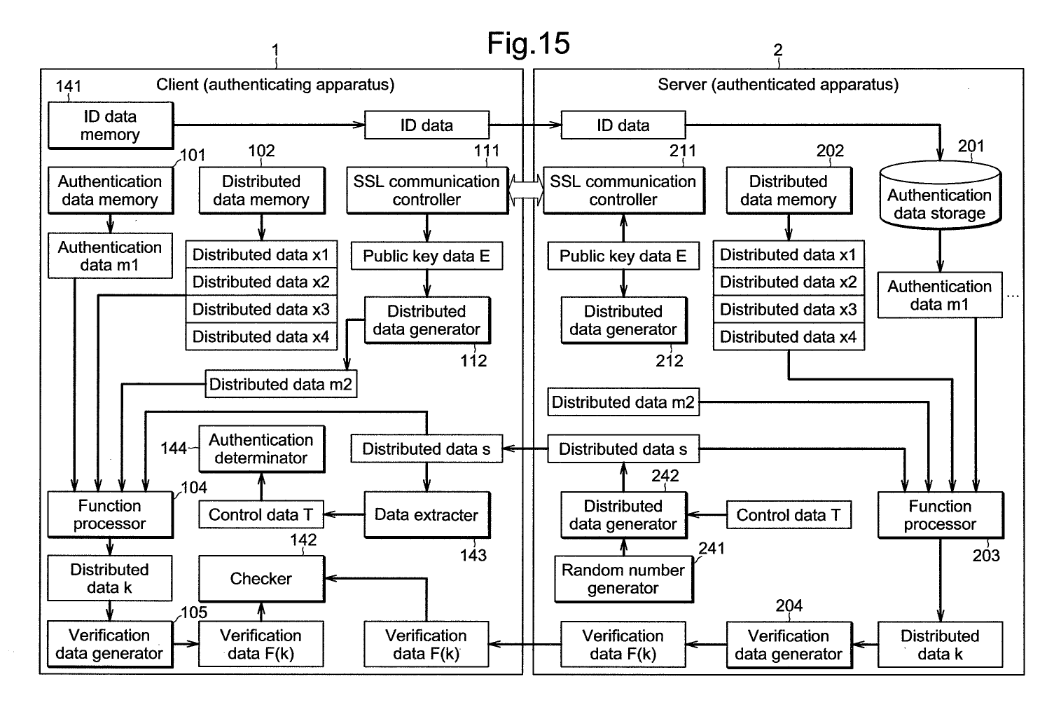

FIG. 15 is a block diagram illustrating an eleventh embodiment of the server and the client shown in FIG. 1. Distributed data s shown in FIG. 15 is different from that in FIG. 14, in that distributed data s is generated by distributed data generator 242 of server (authenticated apparatus) 2 by adding predetermined control data T to random number data generated by random number generator 241; and that distributed data s is transmitted to client 1 along with verification data F(k).

Client 1 has data extractor 143 and authentication determinator 144. Data extractor 143 extracts control data from distributed data s received from server 2. Authentication determinator 144 determines whether or not authentication is granted based on control data T obtained in data extractor 143. Other components in the configuration are the same as those in the example of FIG. 14.

Compared to the example of FIG. 14, distributed data s is generated on server 2 and transmitted to client I in this configuration. Even when intermediary 3 shown in FIG. 1 transmits to client 1 identical distributed data s and verification data F(k) shown in FIG. 15, by copying data communication between client 1 and server 2, authentication determinator 144 denies authentication because of time information, access count information, and access authorization information contained in control data T in distributed data s. Thereby, retry attacks can be prevented. Specifically, client 1 limits authentication based on the time provided in the time information in control data T. For instance, when client 1 compares the time information in control data T received from server 2 against the current time, and determines that a predetermined time or more has elapsed, client 1 denies authentication. Further, client 1 limits authentication based on the number of access provided in the access count information in control data T. For instance, when client 1 compares the access count information in control data T received from server 2 against the current access count, and determines that the count is out of a predetermined range, client 1 denies authentication. Client 1 can also limit authentication based on access authorization provided in the access authorization information in the control data. In the configuration above, even when the intermediary intervening in communication between the authenticated apparatus and the authenticating apparatus intercepts the distributed data transmitted from the authenticated apparatus to the authenticating apparatus, the intermediary cannot obtain the authentication data unless all distributed data are provided, and thus high secrecy is ensured. In addition, using a low degree function reduces calculation load. A low speed calculation device will thus suffice, and the cost can be reduced.

<<Product (Cryptography) Scheme>>

### <Example of Using Control Data in Product Scheme (Shared Key Type)>

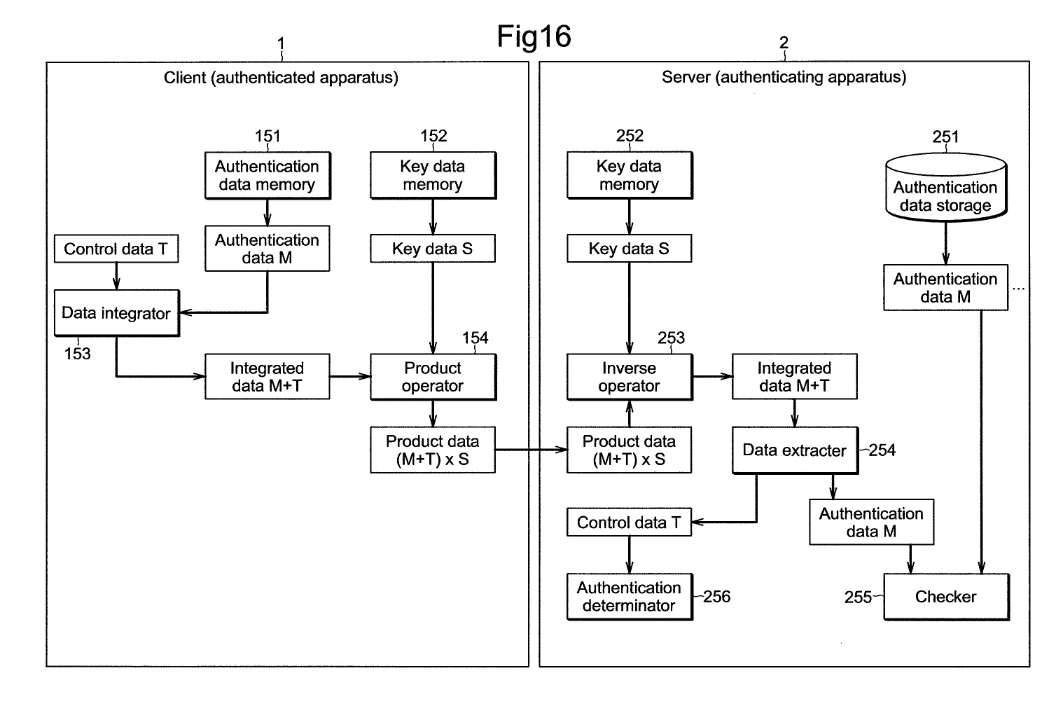

FIG. 16 is a block diagram illustrating a twelfth embodiment of the server and the client shown in FIG. 1. Client (authenticated apparatus) 1 has authentication data memory 151, key data memory 152, data integrator 153, and product operator 154. Authentication data memory 151 secretly stores authentication data M indicating authenticity of client 1. Key data memory 152 secretly stores key data S. Data integrator 153 adds predetermined control data T to authentication data M. Product operator 154 multiplies integrated data M+T obtained in data integrator 153 by key data S of key data memory 152, and thus obtains product data (M+T)×S. When client 1 requests server 2 for authentication, client 1 transmits product data (M+T)×S to server 2.

Server (authenticating apparatus) 2 has authentication data storage 251, key data memory 252, inverse operator 253, data extractor 254, checker 255, and authentication determinator 256. Authentication data storage 251 stores authentication data of each of a plurality of clients, including authentication data M of client 1. Key data memory 252 secretly stores key data S. Inverse operator 253 multiplies product data (M+T)×S received from client 1 by an inverse of key data S in key data memory 252, and thus obtains integrated data M+T. Data extractor 254 retrieves authentication data M and control data T from integrated data M+T obtained in inverse operator 253. Checker 255 compares authentication data M obtained in data extractor 254 against the authentication data stored in authentication data storage 201, and thus verifies authenticity of client 1. Authentication determinator 256 determines whether or not authentication is granted based on control data T obtained in data extractor 254. Other components in the configuration are the same as those in the example of FIG. 15.

In the configuration above, even when intermediary 3 of FIG. 1 intervening in communication between client 1 and server 2 intercepts product data (M+T)×S of FIG. 16 transmitted from client 1 to server 2, intermediary 3 cannot obtain authentication data M without knowing key data S. Further, in accordance with change of contents of control data T due to elapse of the time and other factors, product data (M+T)×S exchanged between client 1 and server 2 changes. Thus, the intermediary cannot receive authentication improperly by copying communication between client 1 and server 2 and using the product data used in the communication, and thereby retry attacks can be prevented. In addition, a simple cryptographic operation, such as product operation and the like, used in processes on the authenticated apparatus and the authenticating apparatus reduces calculation load and thus cost.

<Alternative Example of Using Control Data in Product Scheme (Shared Key Type)>

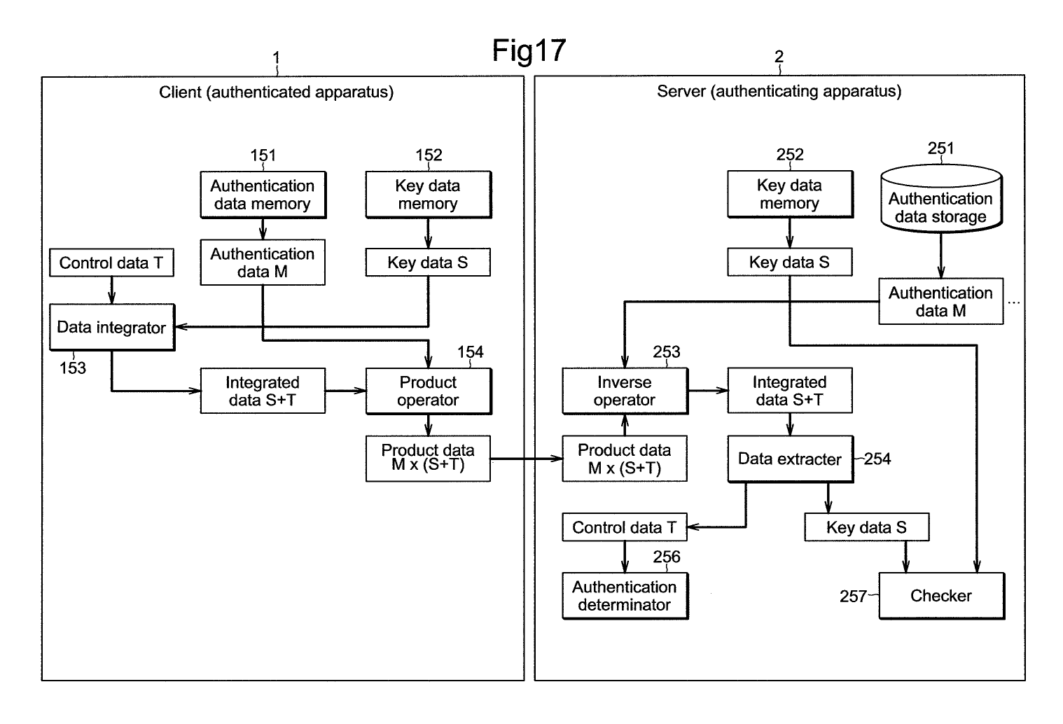

FIG. 17 is a block diagram illustrating a thirteenth embodiment of the server and the client shown in FIG. 1. Contrary to the above-described example of FIG. 16, data integrator 153 of client 1 herein adds predetermined control data T to key data S stored in key data memory 152. Product operator 154 then multiplies integrated data S+T obtained in data integrator 153 by authentication data M, and thus obtains product data M×(S+T). Product data M×(S+T) obtained herein is transmitted to server 2.

Inverse operator 253 of server 2 multiplies product data M×(S+T) received from client 1 by an inverse of authentication data M stored in authentication data storage 251, and thus obtains integrated data S+T. Data extractor 254 then retrieves key data S and control data T from integrated data S+T obtained in inverse operator 253. Checker 257 compares key data S obtained in data extractor 254 against key data S stored in key data memory 252, and then verifies authenticity of client 1. Other components in the configuration are the same as those in the example of FIG. 15.

More specifically, authentication data M are sequentially read out from authentication data storage 251. When checker 257 determines that key data S obtained in data extractor 254 and key data S stored in key data memory 252 are identical, authentication is deemed to have succeeded. When the data are not identical, subsequent authentication data M is read out from authentication data storage 251, and the similar process described above is performed. When no data is identical, authentication is deemed to have failed. In the configuration above, even when intermediary 3 of FIG. 1 intervening in communication between client 1 and server 2 intercepts product data M×(S+T) of FIG. 17 transmitted from client 1 to server 2, intermediary 3 cannot obtain authentication data M without knowing key data S. Further, in accordance with change of contents of control data T due to elapse of the time and other factors, product data M×(S+T) exchanged between client 1 and server 2 changes. Thus, the intermediary cannot receive authentication improperly by copying communication between client 1 and server 2 and using the product data used in the communication, and thereby retry attacks can be prevented. In addition, a simple cryptographic operation, such as product operation and the like, used in processes on the authenticated apparatus and the authenticating apparatus reduces calculation load and thus cost.

<Example of Using Control Data in Product Scheme (Random Number Key Type)>

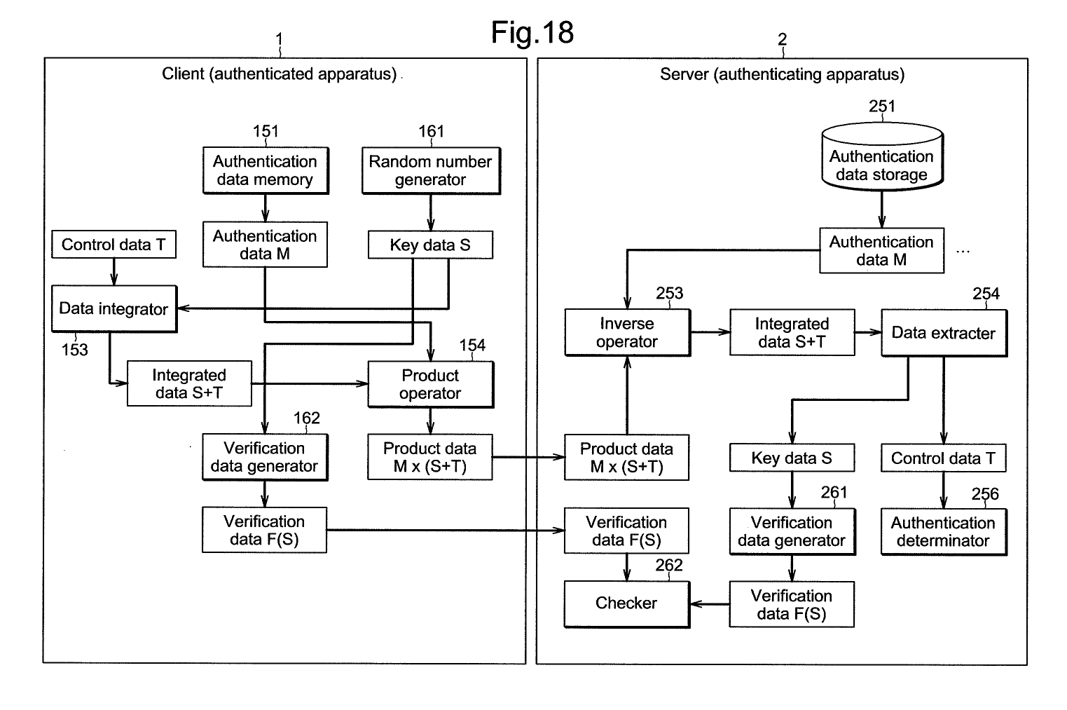

FIG. 18 is a block diagram illustrating a fourteenth embodiment of the server and the client shown in FIG. 1. Client 1 herein has random number generator 161, which generates key data S from random numbers. Data integrator 153 adds predetermined control data T to key data S generated by random number generator 161. Further, client 1 has verification data generator 162, which converts key data S obtained in random number generator 161 by using a one-way function, and thus obtains verification data F(S). Verification data F(S) obtained herein is transmitted to server 2 along with product data M×(S+T).

Server 2 has verification data generator 261 and checker 262. Verification data generator 261 converts key data S obtained in data extractor 254 by using a one-way function identical to the one-way function used in verification data generator 162 of client 1, and thus obtains verification data F(S). Checker 262 compares verification data F(S) received from client 1 against verification data F(S) calculated by verification generator 261, and thus verifies authenticity of client 1.

More specifically, inverse operator 253 sequentially reads out authentication data M from authentication data storage 251. When checker 262 determines that verification data F(S) obtained in verification data generator 261 and verification data F(S) received from client I are identical, authentication is deemed to have succeeded. When the data are not identical, subsequent authentication data M is read out from authentication data storage 251, and the similar process described above is performed. When no data is identical, authentication is deemed to have failed.

Verification data generator 162 of client 1 and verification data generator 261 of server 2 may convert integrated data S+T by using a one-way function so as to obtain verification data F(S+T). In the configuration above, even when intermediary 3 of FIG. 1 intervening in communication between client 1 and server 2 intercepts product data M×(S+T) or verification data F of FIG. 18 transmitted from client 1 to server 2, intermediary 3 cannot obtain the authentication data M without knowing key data S. Further, in accordance with change of contents of control data T due to elapse of the time and other factors, product data M×(S+T) exchanged between client 1 and server 2 changes. Thus, the intermediary cannot receive authentication improperly by copying communication between client 1 and server 2 and using the product data used in the communication, and thereby retry attacks can be prevented. In addition, a simple cryptographic operation, such as product operation and the like, used in processes on the authenticated apparatus and the authenticating apparatus reduces calculation load and thus cost.

<Example of Using Unique Data in Product Scheme (Shared Key Type)>

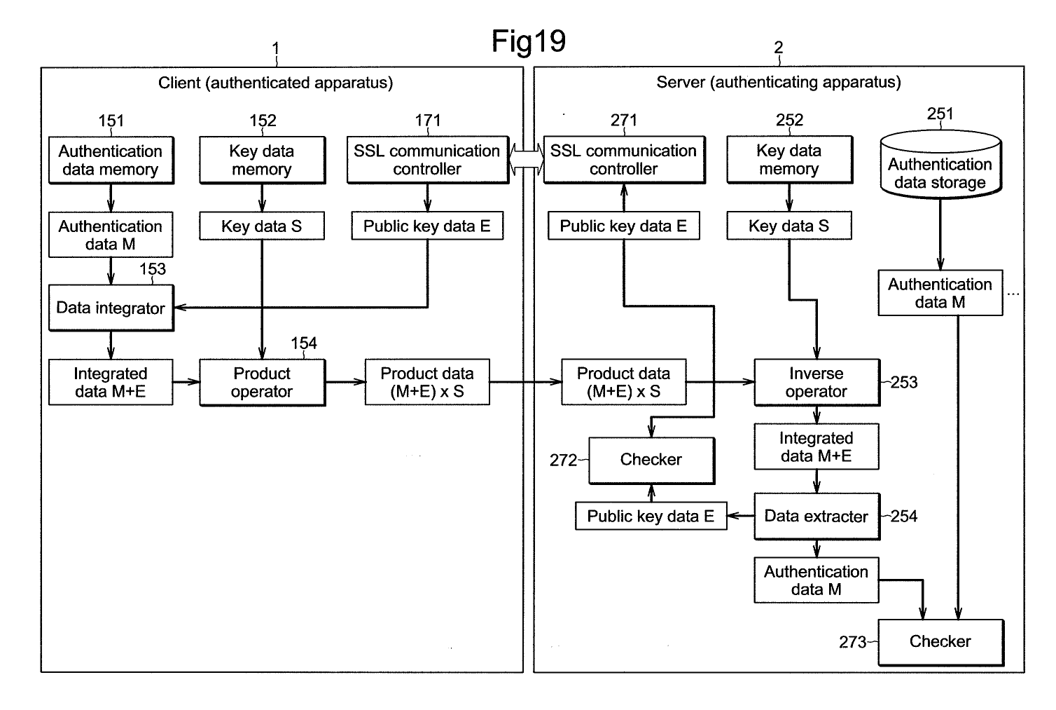

FIG. 19 is a block diagram illustrating a fifteenth embodiment of the server and the client shown in FIG. 1. A configuration is similar to that of the example shown in FIG. 16. In FIG. 19, however, SSL communication is first performed between client 1 and server 2. In a negotiation process of SSL communication, a server certificate containing public key data E of server 2 is transmitted to client 1.

Client 1 has SSL communication controller 171. Data integrator 153 of client 1 adds to authentication data M, public key data E of server 2 obtained therefrom through SSL communication controller 171. Product operator 154 multiplies integrated data M+E obtained in data integrator 153 by key data S stored in key data memory 152, and thus obtains product data (M+E)×S, which is transmitted to server 2.

Inverse operator 253 of server 2 multiplies product data (M+E)×S received from client 1 by an inverse of key data S in key data storage 252, and thus obtains integrated data M+E. Data extractor 254 then retrieves authentication data M and public key data E from integrated data M+E obtained in inverse operator 253.

Server 2 further has checker 272 and checker 273. Checker 272 compares public key data E obtained in data extractor 254 against its own public key data E, which is identical to the data transmitted to client 1 through SSL communication controller 271, and thus verifies authenticity of public key data E. Checker 273 compares authentication data M obtained in data extractor 254 against authentication data M stored in authentication data storage 251, and thus verifies authenticity of client 1. When authentication is successful in both checker 272 and checker 273, authentication is deemed to have succeeded.

In the configuration above, even when the intermediary intervening in communication between the authenticated apparatus and the authenticating apparatus intercepts the encrypted data transmitted from the authenticated apparatus to the authenticating apparatus, the intermediary cannot obtain the authentication data from the encrypted data without knowing the key data, and thus high secrecy is ensured. In addition, a simple cryptographic operation, such as product operation and the like, used in processes on the authenticated apparatus and the authenticating apparatus reduces calculation load and thus cost. In the configuration above in particular, the product data exchanged between client 1 and server 2 is generated based on public key data E of server 2. Thus, even when intermediary 3 is present intervening in communication between client 1 and server 2 shown in FIG. 1, intervention of intermediary 3 is revealed, since public key data of intermediary 3 is different from public key data E of server 2 shown in FIG. 7 because of reasons described below, and thus intermediary attacks are prevented. More specifically, intermediary 3, which does not know the private key owned by server 2, transmits to client 1 a false server certificate in response to an SSL communication start request from client 1 so as to decrypt encrypted communication data, the false server certificate containing a public key associated with a private key owned by the intermediary. Client 1 calculates product data based on the false public key contained in the false server certificate. Meanwhile, server 2 compares in checker 272 the public key against its own authentic public key data E in order to verify authenticity of client 1, the public key being extracted from the inverse operated product data received from intermediary 3 of FIG. 1 spoofing as client 1. Since the public keys do not match, verification fails, and thus it is revealed that an intermediary is intervening in communication between client 1 and server 2. In the configuration above, even when intermediary 3 of FIG. 1 intervening in communication between client 1 and server 2 intercepts product data (M+E)×S of FIG. 18 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

<Alternative Example of Using Unique Data in Product Scheme (Shared Key Type)>

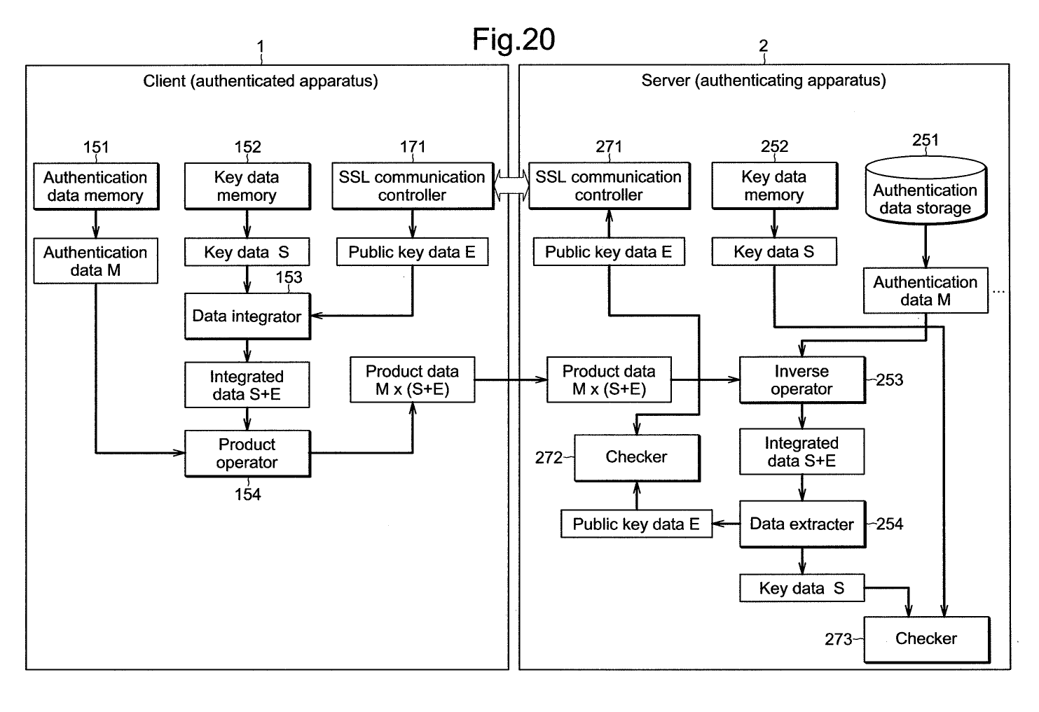

FIG. 20 is a block diagram illustrating a sixteenth embodiment of the server and the client shown in FIG. 1. Contrary to the preceding example, data integrator 153 of client (authenticated apparatus) 1 herein adds public key data E of server 2 obtained through SSL communication controller 171, to key data S stored in key data storage 152. Product operator 154 then multiplies integrated data S+E obtained in data integrator 153 by authentication data M, and thus obtains product data M×(S+E), which is transmitted to server 2.

Inverse operator 253 of server 2 multiplies product data M×(S +E) received from client 1 by an inverse of authentication data M stored in authentication data storage 251, and thus obtains integrated data S+E. Data extractor 254 then retrieves key data S and control data E from integrated data S+E obtained in inverse operator 253. Checker 272 compares public key data E obtained in data extractor 254 against its own public key data E, which is identical to the data transmitted to client 1 through SSL communication controller 271, and thus verifies authenticity of public key data E. Checker 273 compares key data S obtained in data extractor 254 against key data S stored in key data memory 252, and thus verifies authenticity of key data S. When authentication is successful in both checker 272 and checker 273, authentication is deemed to have succeeded. Other components in the configuration are the same as those in the example in FIG. 19.

Instead of public key data E, or along therewith, data associated with a network address, including an IP address and a MAC address, may be added to authentication data M or key data S, similar to the example of FIG. 9. In the configuration above, even when intermediary 3 of FIG. 1 intervening in communication between client 1 and server 2 intercepts product data M×(S+E) of FIG. 20 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

<Example of Using Unique Data in Product Scheme (Random Number Key Type)>

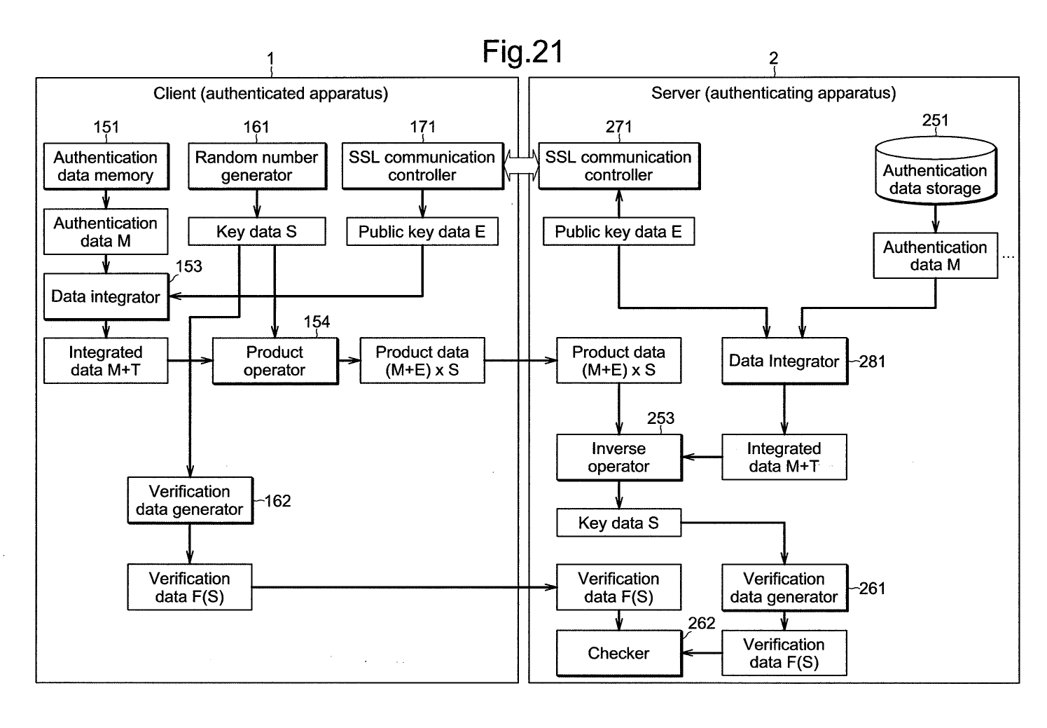

FIG. 21 is a block diagram illustrating a seventeenth embodiment of the server and the client shown in FIG. 1. A configuration is similar to that of the example shown in FIG. 19. In FIG. 21, however, random number generator 161 of client (authenticated apparatus) 1 generates key data S using random numbers. Data integrator 153 adds to authentication data M, public key data E of server 2 obtained therefrom through SSL communication controller 171. Product operator 154 then multiplies integrated data M+E obtained in data integrator 153 by key data S obtained in random number generator 161, and thus obtains product data (M+E)×S. Further, verification data generator 162 of client 1 converts key data S obtained in random number generator 161 by using a one-way function, and thus obtains verification data F(S). Verification data F(S) obtained herein is transmitted to server 2 along with product data (M+E)×S.

Server 2 has data integrator 281, which adds its own public key data E to authentication data M, public key data E being identical to the data transmitted to client 1 through SSL communication controller 271, authentication data M being stored in authentication data storage 251. Inverse operator 253 multiplies product data (M+E)×S received from client 1 by an inverse of integrated data M+E obtained in data integrator 281, and thus retrieves key data S. Verification data generator 261 converts key data S obtained in inverse operator 253 by using a one-way function identical to the one-way function used in verification data generator 162 of client 1, and thus obtains verification data F(S). Checker 262 compares verification data F(S) received from client 1 against verification data F(S) obtained in verification data generator 261, and thus verifies authenticity of client 1. Other components in the configuration are the same as those in the example in FIG. 19. In the configuration above, even when intermediary 3 of FIG. 1 intervening in communication between client 1 and server 2 intercepts product data (M+E)×S of FIG. 21 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

<Alternative Example of Using Unique Data in Product Scheme (Random Number Key Type)>

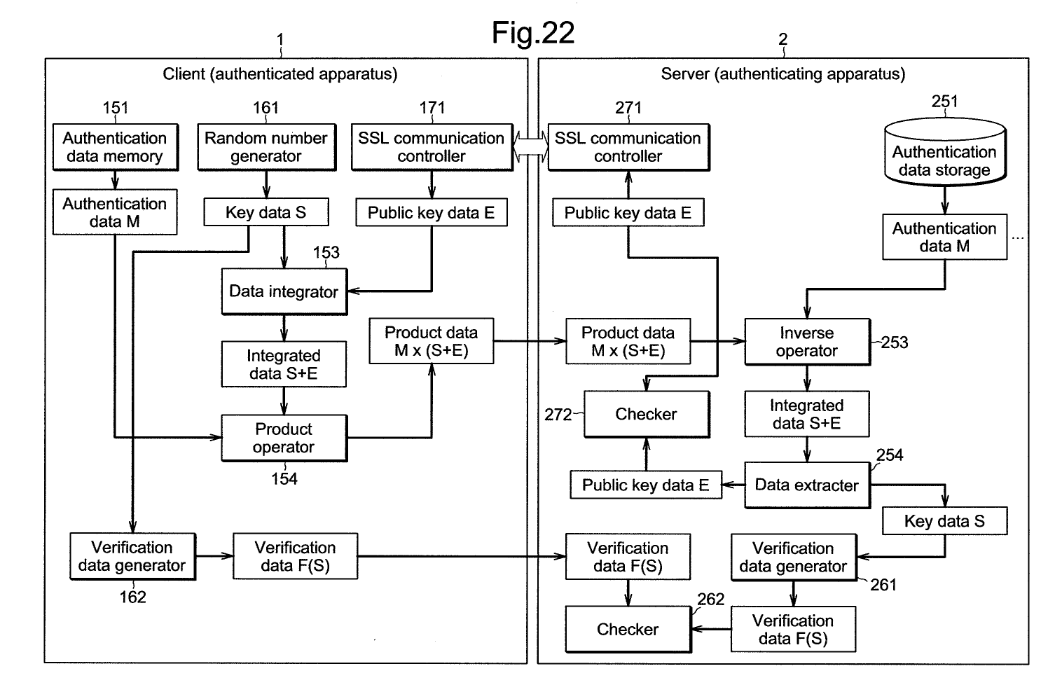

FIG. 22 is a block diagram illustrating an eighteenth embodiment of the server and the client shown in FIG. 1. Contrary to the preceding example of FIG. 21, data integrator 153 of client 1 herein adds public key data E of server 2 obtained through SSL communication controller 171, to key data S obtained in random number generator 161. Product operator 154 then multiplies integrated data S+E obtained herein by authentication data M, and thus obtains product data M×(S+E), which is transmitted to server 2.

Inverse operator 253 of server 2 multiplies product data M×(S+E) received from client 1 by an inverse of authentication data M stored in authentication data storage 251, and thus obtains integrated data S+E. Data extractor 254 then retrieves key data S and public key data E from integrated data S+E obtained in inverse operator 253. Checker 272 compares public key data E obtained in data extractor 254 against its own public key data E, which is identical to the data transmitted to client 1 through SSL communication controller 271, and thus verifies authenticity of public key data E.

Verification data generator 261 of server 2 converts key data S obtained in data extractor 254 by using a one-way function identical to the one-way function used in verification data generator 162 of client 1, and thus obtains verification data F(S). Checker 262 compares verification data F(S) received from client 1 against verification data F(S) obtained in verification data generator 261, and thus verifies authenticity of client 1. When authentication is successful in both checker 272 and checker 262, authentication is deemed to have succeeded. Other components in the configuration are the same as those in the example in FIG. 21. In the configuration above, even when intermediary 3 of FIG. 1 intervening in communication between client 1 and server 2 intercepts product data M×(S+E) of FIG. 22 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

<Example of Reverse Authentication in Product Scheme>

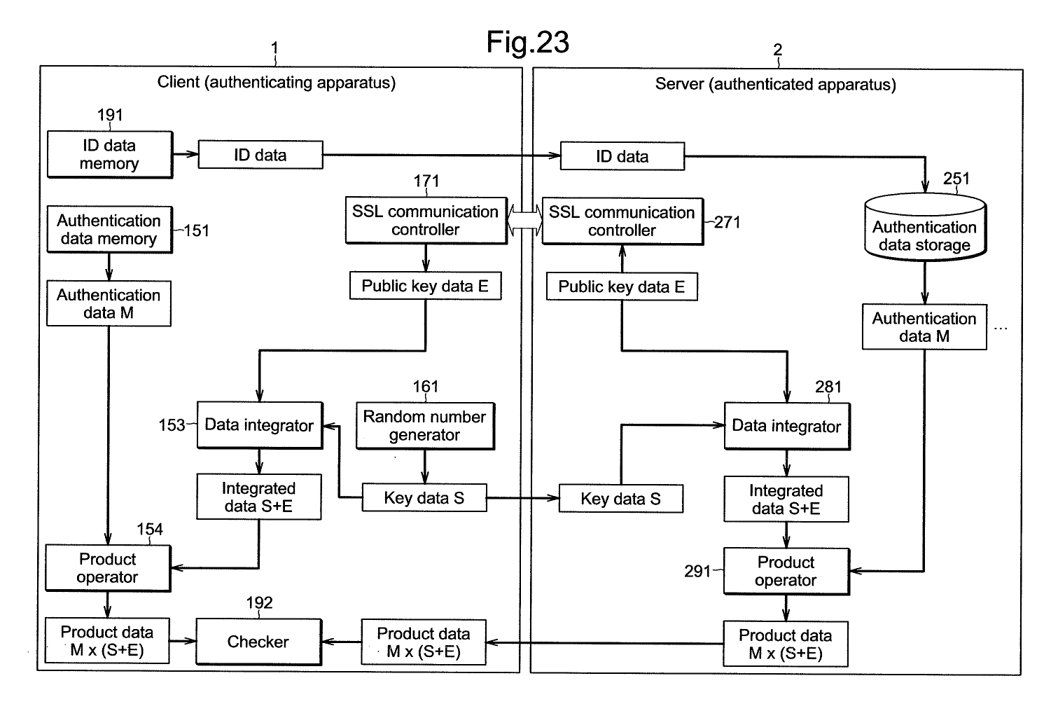

FIG. 23 is a block diagram illustrating a nineteenth embodiment of the server and the client shown in FIG. 1. Contrary to the preceding example of FIG. 22, client 1 herein verifies authenticity of server 2. Specifically, the client serves as an authenticating apparatus, and the server serves as an authenticated apparatus.

Client (authenticating apparatus) 1 has ID data memory 191, which stores ID data identifying its own authentication data M. The ID data and key data s generated by random number generator 161 are transmitted to server 2.

Server (authenticated apparatus) 2 adds public key data E of server 2, which is identical to the data transmitted to client 1 through SSL communication controller 271, to key data S received from client 1. Product operator 291 multiplies integrated data S+E obtained in data integrator 281 by authentication data M stored in authentication data storage 251, and thus obtains product data (S+E)×M, which is transmitted to client 1.

Data integrator 153 of client 1 adds public key data E of server 2 obtained therefrom through SSL communication controller 171, to key data S obtained in random number generator 161. Product operator 154 multiplies integrated data S+E obtained in data integrator 153 by authentication data M, and thus obtains product data (S+E)×M. Checker 192 compares product data (S+E)×M received from server 2 against product data (S+E)×M obtained in product operator 154, and thus verifies authenticity of server 2. Other components in the configuration are the same as those in the example of FIG. 21. In the configuration above, even when intermediary 3 of FIG. 1 intervening in communication between client 1 and server 2 intercepts product data (S+E)×M of FIG. 23 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

<Alternative Example of Reverse Authentication in Product Scheme>

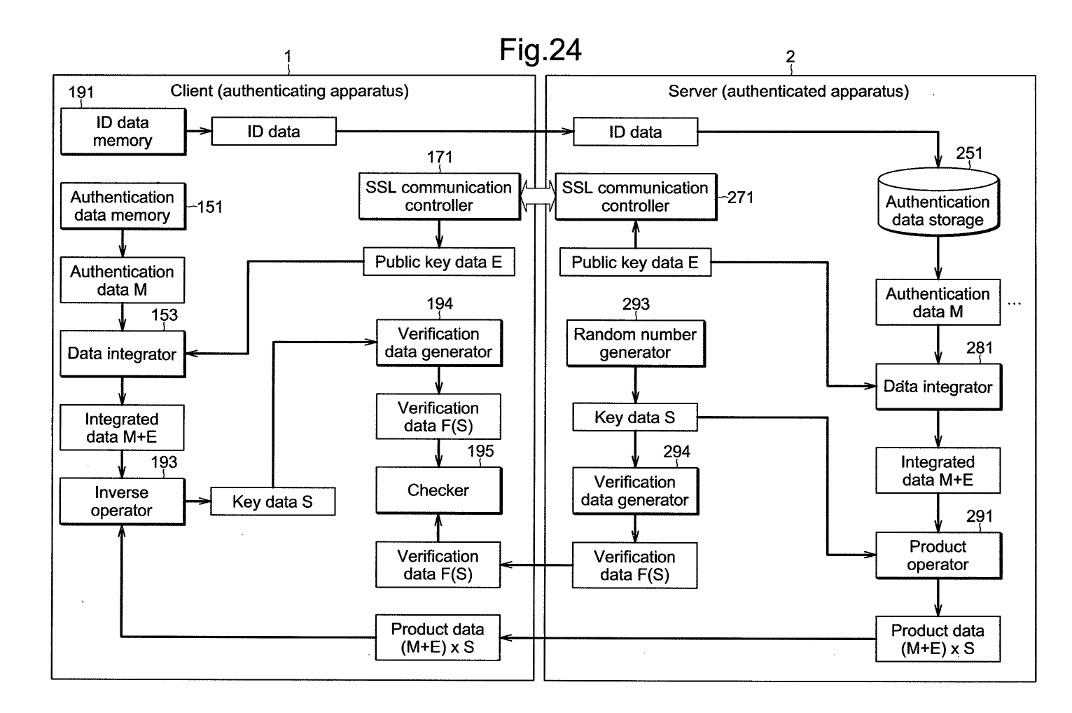

FIG. 24 is a block diagram illustrating a twentieth embodiment of the server and the client shown in FIG. 1. Different from the example of FIG. 23, server 2 in FIG. 24 has random number generator 293 and verification data generator 294. Random number generator 293 generates key data S from random numbers. Verification data generator 294 converts key data S obtained in random number generator 293 by using a one-way function, and thus obtains verification data F (S). Verification data F(S) obtained herein and product data (M+E)×S are transmitted to client 1, the product data being obtained in product operator 291 in a reverse order of the example of FIG. 23.

Client 1 has inverse operator 193, verification data generator 194, and checker 195. Inverse operator 193 multiplies product data (M+E)×S received from client 1 by an inverse of integrated data M+E obtained in data integrator 153, and thus obtains key data S. Verification data generator 194 converts key data S obtained in inverse operator 193 by using a one-way function identical to the one-way function used in verification data generator 294 of server 2, and thus obtains verification data F(S). Checker 195 compares verification data F(S) received from server 2 against verification data F(S) obtained in verification data generator 194, and thus verifies authenticity of server 2. Other components in the configuration are the same as those in the example of FIG. 23. In the configuration above, even when intermediary 3 of FIG. 1 intervening in communication between client 1 and server 2 intercepts product data (M+E)×S of FIG. 24 transmitted from client 1 to server 2, intermediary 3 cannot obtain authentication data M without knowing key data S. In addition, a simple cryptographic operation, such as product operation and the like, used in processes on the authenticated apparatus and the authenticating apparatus reduces calculation load and thus cost.

The secret authentication system according to the present invention is capable of ensuring high secrecy and concurrently reducing calculation load to achieve cost reduction. Further the secret authentication system has effects in preventing a variety of intermediary attacks. Thus, the secret authentication system is effectively applied as a secret authentication system in which an authenticated apparatus notifies an authenticating apparatus of authentication data, so that authentication is performed while others are kept from knowing the data.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A secret authentication system in which an authenticating apparatus and an authenticated apparatus perform authentication therebetween using a function, wherein:
the authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function;
the authenticated apparatus and the authenticating apparatus share the type of the function and a portion of plurality of distributed data including the authentication data, the rule data, and the function data;
the authenticated apparatus performs a calculation for the distributed data unshared with the authenticating apparatus in a process difficult for a third party to perform a back calculation, so as to obtain verification data, and transmits the verification data to the authenticating apparatus;
the authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus;
the authenticated apparatus generates data containing control data as one of the distributed data, and transmits the generated data to the authenticating apparatus; and
the authenticating apparatus retrieves the control data from the distributed data containing the control data, and determines whether to grant authentication based on the control data.

2. The secret authentication system according to claim 1, wherein the shared distributed data includes the authentication data and the rule data.

3. The secret authentication system according to claim 1, wherein the distributed data shared between the authenticated apparatus and the authenticating apparatus and stored in the authenticating apparatus is the authentication data.

4. A secret authentication system wherein:
an authenticated apparatus generates integrated data by adding control data to one of authentication data and key data, the authentication data indicating authenticity of one of the authenticated apparatus and a user thereof; obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to an authenticating apparatus; and
the authenticating apparatus decrypts the encrypted data received from the authenticated apparatus; extracts the control data; and determines whether to grant authentication based on the control data.

5. The secret authentication system according to claim 1, wherein the control data includes information related to time one of when the control data is generated and when the control data is effective.

6. The secret authentication system according to claim 1, wherein the control data includes information related to the number of access from the authenticated apparatus to the authenticating apparatus.

7. The secret authentication system according to claim 1, wherein the control data includes information related to authorization of access from the authenticated apparatus to the authenticating apparatus.

8. A secret authentication system in which an authenticating apparatus and an authenticated apparatus perform authentication therebetween using a function, wherein:
the authenticating apparatus and the authenticated apparatus determine the function based on authentication data, rule data, function data, and a type of the function, the authentication data indicating authenticity of one of the authenticated apparatus and a user thereof, the rule data specifying the authentication data using the function, the function data determining the function;
the authenticated apparatus and the authenticating apparatus share the type of the function and a portion of plurality of distributed data including the authentication data, the rule data, and the function data;
the authenticated apparatus performs a calculation for the distributed data unshared with the authenticating apparatus in a process difficult for a third party to perform a back calculation, so as to obtain verification data, and transmits the verification data to the authenticating apparatus;
the authenticating apparatus verifies authenticity of the authenticated apparatus, based on the authentication data stored in the authenticating apparatus for each authenticated apparatus and user, the distributed data shared between the authenticated apparatus and the authenticating apparatus and stored in the authenticating apparatus, and the verification data received from the authenticated apparatus;
the authenticated apparatus generates at least a portion of the distributed data from unique data of one of the authenticated apparatus and the authenticating apparatus;
the authenticating apparatus generates the distributed data identical to the data of the authenticated apparatus, from the unique data of one of the authenticated apparatus and the authenticating apparatus.

9. The secret authentication system according to claim 1, wherein the shared distributed data includes the authentication data and the rule data.

10. The secret authentication system according to claim 1, wherein the distributed data shared between the authenticated apparatus and the authenticating apparatus and stored in the authenticating apparatus is the authentication data.

11. A secret authentication system wherein:
an authenticated apparatus generates integrated data by adding unique data of one of the authenticated apparatus and an authenticating apparatus, to one of authentication data and key data, the authentication data indicating authenticity of one of the authenticated apparatus and a user thereof, obtains encrypted data by encrypting the integrated data using one of the authentication data and the key data not used for the integrated data as an encryption key, such as in a calculation of product data by multiplying one of the authentication data and the key data not used for the integrated data by the integrated data; and transmits the encrypted data to the authenticating apparatus; and
the authenticating apparatus verifies authenticity of the authenticated apparatus, based on the unique data of one of the authenticated apparatus and the authenticating apparatus, the encrypted data received from the authenticated apparatus, and authentication data stored in the authenticating apparatus.

12. The secret authentication system according to claim 8, wherein the unique data includes information related to a public key of the authenticating apparatus.

13. The secret authentication system according to claim 8, wherein the unique data includes information related to a network address of one of the authenticated apparatus and the authenticating apparatus.

14. The secret authentication system according to claim 1, wherein:
the authenticating apparatus obtains response data by performing a calculation of distributed data verified with the verification data and of the unshared distributed data in a process different from a process of obtaining the verification data, and transmits the response data to the authenticated apparatus; and
the authenticated apparatus verifies authenticity of the authenticating apparatus, based on unshared distributed data stored in the authenticated apparatus and the response data received from the authenticating apparatus.

15. The secret authentication system according to claim 1, wherein one of the authenticated apparatus and the authenticating apparatus generates at least a portion of the shared distributed data, and transmits to the other apparatus.
